(19) United States
(12) Patent Application Publication
(10) Pub. No.: US 2020/0136541 A1
(43) Pub. Date: Apr. 30, 2020

(54) SHEET CONVEYANCE APPARATUS AND IMAGE FORMING APPARATUS

(71) Applicant: CANON KABUSHIKI KAISHA, Tokyo (JP)

(72) Inventor: Kenji Morita, Toride-shi (JP)

(21) Appl. No.: 16/661,920

(22) Filed: Oct. 23, 2019

(30) Foreign Application Priority Data
Oct. 31, 2018 (JP) 2018-205555

(51) Int. Cl. H02P 21/18; H02P 21/22; B65H 7/04; B65H 5/06; B65H 7/20

(52) U.S. Cl. CPC H02P 21/18; H02P 21/22; G03G 15/6529; B65H 5/06; B65H 7/20; B65H 7/04

(57) ABSTRACT

A sheet conveyance apparatus having a motor and a detector to detect a sheet conveyance abnormality. The motor includes a discriminator to determine whether motor rotation is abnormal, and a controller having a first mode to reduce a deviation between a determined motor rotation phase and an instructed phase, and a second mode to control a driving current based on a current having a previously determined magnitude. The controller switches from the second to the first mode if a motor rotor target speed value becomes larger than a predetermined value during the second mode after motor driving is started in the second mode. Where the motor was stopped due to the detector detecting a sheet conveyance abnormality and the discriminator determine that motor rotation is abnormal, the controller starts and maintains the motor driving in the second mode, even if the target speed value becomes larger than the predetermined value.

### BACKGROUND

### Field

Aspects of the present disclosure generally relate to control over a motor in a sheet conveyance apparatus and an image forming apparatus.

### Description of the Related Art

Conventional methods for controlling a motor include a control method called vector control, which controls a motor by controlling a current value in a rotating coordinate system that is based on the rotation phase of a rotor of the motor. Specifically, there is a known control method which controls a motor by performing phase feedback control for controlling a current value in the rotating coordinate system in such a manner that a deviation between the instructed phase and the rotation phase of a rotor becomes smaller. Furthermore, there is also a known control method which controls a motor by performing speed feedback control for controlling a current value in the rotating coordinate system in such a manner that a deviation between the instructed speed and the rotational speed of a rotor becomes smaller.

In the vector control, a driving current flowing through the winding of a motor is expressed by a q-axis component (torque current component), which is a current component for generating a torque required for the rotor to rotate, and a d-axis component (excitation current component), which is a current component affecting the intensity of a magnetic flux that penetrates through the winding of a motor. The value of a torque current component being controlled according to a change in load torque applied to the rotor causes a torque required for rotation to be efficiently generated. As a result, an increase in motor sound or an increase in power consumption caused by a surplus torque is prevented or reduced.

The vector control requires a configuration for determining the rotation phase of a rotor. U.S. Pat. No. 8,970,146 discusses a configuration which determines an induced voltage that is generated at the winding due to the rotation of the rotor, with use of the values of a resistance R of the winding and an inductance L of the winding (hereinafter referred to as “control parameters”), and determines the rotation phase of the rotor based on the induced voltage.

The values of control parameters which are used to determine the induced voltage in the method discussed in U.S. Pat. No. 8,970,146 are values specific to a motor, and are previously set based on the values of a resistance R of the winding and an inductance L of the winding of a motor which is to be mounted to a motor control device.

For example, if vector control is performed with a motor B, which differs in type from a motor A, mounted in a motor control device in which the values of control parameters are previously set to values corresponding to the motor A, it may become impossible or at least not possible to determine the rotation phase of a rotor of the motor B with a high degree of accuracy. As a result, control over the motor B may become unstable, so that step-out of the motor B may occur.

Even if, after the occurrence of step-out of the motor B, driving of the motor B is resumed with vector control, step-out of the motor B may occur again due to the values of control parameters previously set in the motor control device being values corresponding to the motor A. In this way, if the motor B is mounted to the motor control device in which the values of control parameters corresponding to the motor A are set, step-out of the motor B may repetitively occur due to the values of control parameters not corresponding to the motor B being set. For example, in an image forming apparatus which is configured to convey sheets, if step-out of a motor which drives the conveyance roller repetitively occurs, it may become impossible to convey sheets.

### SUMMARY

Aspects of the present disclosure are generally directed to preventing or reducing an abnormality of rotation of a motor from repetitively occurring.

According to an aspect of the present disclosure, a sheet conveyance apparatus includes a conveyance unit configured to convey a sheet, a motor configured to drive the conveyance unit, a motor control device configured to control driving of the motor based on an instructed phase representing a target phase of a rotor of the motor, a sheet sensor configured to detect presence or absence of the sheet, a first detector configured to detect an abnormality of conveyance of the sheet based on a result of detection performed by the sheet sensor, and a first controller configured to control conveyance of the sheet performed by the conveyance unit and to control the motor control device in such a way as to stop driving of the motor in response to an abnormality of conveyance of the sheet being detected by the first detector, wherein the motor control device includes a second detector configured to detect a driving current flowing through a winding of the motor, a phase determiner configured to determine a rotation phase of the rotor based on the driving current detected by the second detector and a previously set control value, a second controller including a first mode which controls the driving current flowing through the winding of the motor in such a manner that a deviation between the rotation phase determined by the phase determiner and the instructed phase is reduced, and a second mode which controls the driving current based on a current having a previously determined magnitude, wherein the second controller is configured to switch a control mode for controlling the driving current from the second mode to the first mode in a case where a value corresponding to a target speed of the rotor becomes a value larger than a predetermined value during execution of the second mode after driving of the motor is started with the second mode, and a discriminator configured to determine whether rotation of the motor is abnormal, and wherein, in a case where driving of the motor has been stopped due to an abnormality of conveyance of the sheet being detected by the first detector and it is determined by the discriminator that rotation of the motor is abnormal, the second controller starts driving of the motor with the second mode and maintains the second mode even if the value corresponding to the target speed becomes larger than the predetermined value.

Further features of the present disclosure will become apparent from the following description of exemplary embodiments with reference to the attached drawings.

### BRIEF DESCRIPTION OF THE DRAWINGS

FIG. 1 is a sectional view illustrating an image forming apparatus according to a first exemplary embodiment.

FIG. 2 is a block diagram illustrating a control configuration of the image forming apparatus according to the first exemplary embodiment.

FIG. 3 is a diagram illustrating a relationship between a two-phase motor having A-phase and B-phase and a rotating coordinate system expressed by a d-axis and a q-axis.

FIG. 4 is a block diagram illustrating a configuration of a motor control device according to the first exemplary embodiment.

FIG. 5 is a block diagram illustrating a configuration of an instruction generator.

FIG. 6 is a diagram illustrating an example of a method of performing a micro-step drive system.

FIG. 7 is a diagram used to explain switching of control methods for a motor.

FIGS. 8A and 8B are diagrams illustrating an example of a deviation between an instructed phase and a rotation phase.

FIG. 9 is a flowchart illustrating a control method for a motor according to the first exemplary embodiment.

FIG. 10 is a diagram used to explain a method for discriminating types of motors.

FIG. 11 is a flowchart illustrating a control method for a motor according to a second exemplary embodiment.

FIG. 12 is a block diagram illustrating a configuration of a motor control device which performs speed feedback control.

FIG. 13 is a diagram illustrating a relationship between a motor having A-phase and B-phase, a rotating coordinate system expressed by a d-axis and a q-axis, and a rotating coordinate system expressed by a y-axis and a d-axis.

FIG. 14 is a block diagram illustrating a configuration of a motor control device according to a fourth exemplary embodiment.

FIG. 15 is a diagram illustrating an example of a configuration of a low-pass filter which reduces signals of a predetermined frequency band.

FIG. 16 is a block diagram illustrating a configuration of a phase determiner.

### DESCRIPTION OF THE EMBODIMENTS

Various exemplary embodiments, features, and aspects will be described in detail below with reference to the drawings. However, for example, the shapes and relative arrangements of constituent components described in the following exemplary embodiments can be altered as appropriate according to configurations or various conditions of apparatuses to which the disclosure is applied, and the scope should not be construed to be limited to the following exemplary embodiments. Furthermore, while, in the following description, a case where a motor control device is provided in an image forming apparatus is described, the apparatus in which the motor control device is provided is not limited to image forming apparatuses. For example, the motor control device can also be used for sheet conveyance apparatuses for conveying sheets of, for example, a recording medium or a document (original).

### [Image Forming Apparatus]

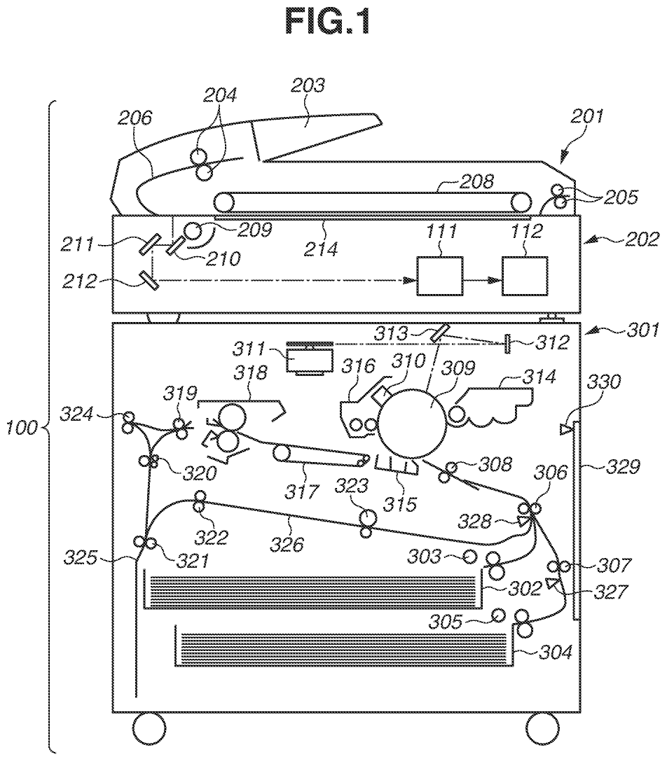

FIG. 1 is a sectional view illustrating a configuration of a copying machine of the monochrome electrophotographic type (hereinafter referred to as an “image forming apparatus”) 100 including a sheet conveyance apparatus according to a first exemplary embodiment. Furthermore, the image forming apparatus is not limited to a copying machine, but can be, for example, a facsimile apparatus, a printing machine, or a printer. Moreover, the recording type is not limited to an electrophotographic type, but can be, for example, an inkjet type. Additionally, the type of the image forming apparatus can be any one of monochrome type and color type.

First, a configuration and a function of the image forming apparatus 100 are described with reference to FIG. 1. As illustrated in FIG. 1, the image forming apparatus 100 includes a document feeding device 201, a reading device 202, and an image printing device 301.

A document stacked on a document stacking unit 203 of the document feeding device 201 is fed by feeding rollers 204 and is conveyed onto a document glass plate 214 of the reading device 202 along a conveyance guide 206. Moreover, the document is conveyed along a conveyance belt 208, and is then discharged to a sheet discharge tray (not illustrated) by sheet discharge rollers 205. Reflected light from the image of the document illuminated by an illumination system 209 at the reading position of the reading device 202 is guided to an image reading unit 111 by an optical system including reflecting mirrors 210, 211, and 212, and is then converted into an image signal by the image reading unit 111. The image reading unit 111 includes, for example, a lens, a charge-coupled device (CCD) sensor, which is a photoelectric conversion element, and a drive circuit for the CCD sensor. An image signal output from the image reading unit 111 is subjected to various correction processing operations by an image processing unit 112, which is configured with a hardware device such as an application specific integrated circuit (ASIC), and is then output to the image printing device 301. In the above-described way, reading of the document is performed. Thus, the document feeding device 201 and the reading device 202 function as a document reading device.

Moreover, reading modes for a document include a first reading mode and a second reading mode. The first reading mode is a mode for reading the image of a document conveyed at a fixed speed with the illumination system 209 and the optical system fixed at a predetermined position. The second reading mode is a mode for reading the image of a document placed on the document glass plate 214 of the reading device 202 with the illumination system 209 and the optical system moving at a fixed speed. Usually, the image of a sheet-like document is read in the first reading mode, and the image of a bound document, such as a book or a booklet, is read in the second reading mode.

Sheet storage trays 302 and 304 are provided inside the image printing device 301. The sheet storage trays 302 and 304 allow respective different types of recording media to be stored therein. For example, sheets of plain paper of A4 size are stored in the sheet storage tray 302, and sheets of heavy paper of A4 size are stored in the sheet storage tray 304. Furthermore, the recording medium is a medium on which an image is to be formed by an image forming apparatus, and, for example, paper, resin sheet, cloth, overhead projector (OHP) sheet, and label are included in the recording medium.

A sheet stored in the sheet storage tray 302 is fed by a pickup roller 303 and is then conveyed to a registration roller 308 by a conveyance roller 306. Moreover, a sheet stored in the sheet storage tray 304 is fed by a pickup roller 305 and is then conveyed to the registration roller 308 by a conveyance roller 307 and the conveyance roller 306.

In the first exemplary embodiment, sheet sensors 327 and 328, which detect the presence or absence of a sheet, are provided at the upstream side of the conveyance roller 307 and at the upstream side of the conveyance roller 306, respectively. As described below, detection of jamming is performed based on results of detection performed by the sheet sensors 327 and 328. Furthermore, the positions at which the sheet sensors 327 and 328 are provided are not limited to the positions illustrated in FIG. 1. Moreover, while, in the first exemplary embodiment, the sheet sensors 327 and 328 are provided at the upstream side of the conveyance roller 307 and at the upstream side of the conveyance roller 306, respectively, actually, additional sheet sensors are provided also at other positions in the conveyance path inside the image forming apparatus 100.

The image forming apparatus 100 in the first exemplary embodiment is provided with a door 329, which allows the user to remove a sheet or sheets remaining in the conveyance path. The user is allowed to open the door 329 to remove a sheet or sheets remaining in the conveyance path. Moreover, the image forming apparatus 100 in the first exemplary embodiment is provided with a door sensor 330, which detects opening and closing of the door 329.

An image signal output from the reading device 202 is input to an optical scanning device 311, which includes a semiconductor laser and a polygon mirror. Moreover, the outer circumferential surface of a photosensitive drum 309 is electrically charged by a charging device 310. After the outer circumferential surface of the photosensitive drum 309 is electrically charged, laser light corresponding to the image signal input to the optical scanning device 311 from the reading device 202 is radiated onto the outer circumferential surface of the photosensitive drum 309 from the optical scanning device 311 via the polygon mirror and mirrors 312 and 313. As a result, an electrostatic latent image is formed on the outer circumferential surface of the photosensitive drum 309.

Next, the electrostatic latent image is developed with toner in a developing device 314, so that a toner image is formed on the outer circumferential surface of the photosensitive drum 309. The toner image formed on the photosensitive drum 309 is transferred to a recording medium by a transfer charging device 315, which is provided at a position facing the photosensitive drum 309 (transfer position). In conformity with such transfer timing, the registration roller 308 conveys a recording medium to the transfer position.

In the above-described way, a recording medium having a toner image transferred thereto is conveyed to a fixing device 318 by a conveyance belt 317, and is heated and pressed by the fixing device 318, so that the toner image is fixed to the recording medium. In this way, an image is formed on the recording medium by the image forming apparatus 100.

In a case where image formation is performed in a one-sided printing mode, a recording medium having passed through the fixing device 318 is discharged to a sheet discharge tray (not illustrated) by sheet discharge rollers 319 and 324, Moreover, in a case where image formation is performed in a two-sided printing mode, after the first surface of a recording medium is subjected to fixing processing by the fixing device 318, the recording medium is conveyed to a reversing path 325 by the sheet discharge roller 319, a conveyance roller 320, and a reversing roller 321. After that, the recording medium is conveyed to the registration roller 308 by conveyance rollers 322 and 323, so that an image is formed on the second surface of the recording medium by the above-mentioned method. After that, the recording medium is discharged to the sheet discharge tray (not illustrated) by the sheet discharge rollers 319 and 324.

Moreover, a recording medium having an image formed on the first surface thereof is discharged face-down to outside the image forcing apparatus 100, the recording medium having passed through the fixing device 318 passes through the sheet discharge roller 319 and is then conveyed in a direction toward the conveyance roller 320. After that, immediately before the trailing edge of the recording medium passes through the nip portion of the conveyance roller 320, the rotation of the conveyance roller 320 is reversed, so that the recording medium with the first surface thereof facing downward is discharged to outside the image forming apparatus 100 via the sheet discharge roller 324.

Thus far is the description about the configuration and function of the image forming apparatus 100. Furthermore, the load in the first exemplary embodiment refers to an object which is to be driven by a motor. For example, each of various rollers (conveyance rollers) such as the feeding rollers 204, the pickup rollers 303 and 305, the registration roller 308, and sheet discharge roller 319 corresponds to the load in the first exemplary embodiment. Moreover, for example, each of the photosensitive drum 309 and the developing device 314 also corresponds to the load in the first exemplary embodiment. The motor control device in the first exemplary embodiment can be applied to a motor or motors which drive these loads.

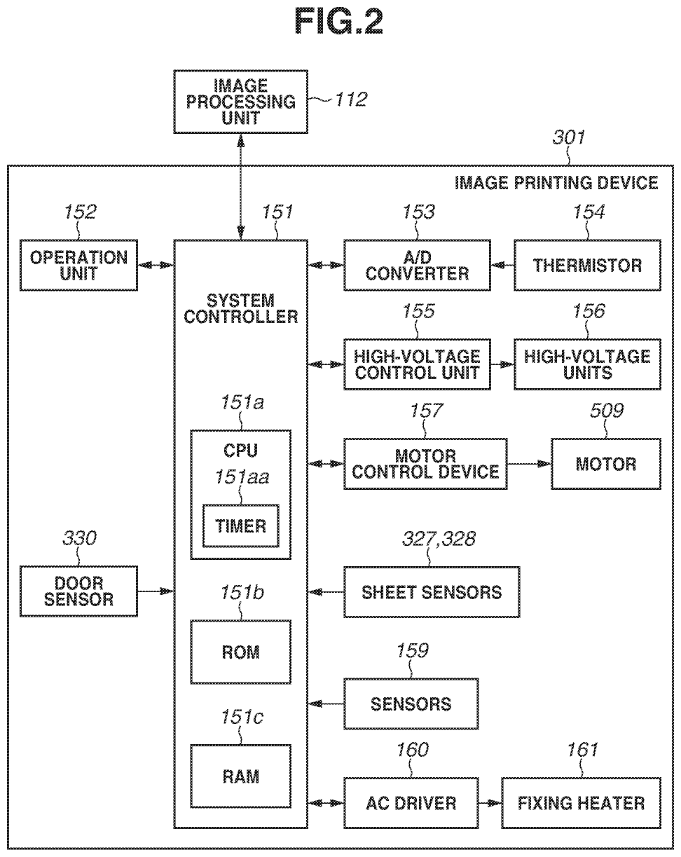

FIG. 2 is a block diagram illustrating an example of a control configuration of the image forming apparatus 100. As illustrated in FIG. 2, a system controller 151 includes a central processing unit (CPU) 151a, a read-only memory (ROM) 151b, and a random access memory (RAM) 151c. Moreover, the system controller 151 is connected to the image processing unit 112, an operation unit 152, an analog-digital (A/D) converter 153, a high-voltage control unit 155, a motor control device 157, sensors 159, an alternating current (AC) driver 160, the sheet sensors 327 and 328, and the door sensor 330. The system controller 151 is able to perform transmission and reception of data and commands with the connected units.

The CPU 151a performs various sequences related to a predetermined image forming sequence by reading out various programs stored in the ROM 151b and executing the read-out programs.

The RAM 151c is a storage device. The RAM 151c stores various pieces of data, such as setting values for the high-voltage control unit 155, instructed values for the motor control device 157, and information which is received from the operation unit

The system controller 151 transmits, to the image processing unit 112, various pieces of setting value data for the devices provided inside the image forming apparatus 100, which are required for the image processing unit 112 to perform image processing. Additionally, the system controller 151 receives signals output from the sensors 159 and sets setting values for the high-voltage control unit 155 based on the received signals.

The high-voltage control unit 133 supplies required voltages to high-voltage units 156 (for example, the charging device 310, the developing device 314, and the transfer charging device 315) according to the setting values set by the system controller 151.

The motor control device 157 controls a motor 509 according to an instruction output from the CPU 151a. Furthermore, while, in FIG. 2, only the motor 509 is illustrated as a motor in the image forming apparatus 100, actually, two or more motors are provided in the image forming apparatus 100. Moreover, a configuration in which a single motor control device controls a plurality of motors can be employed. Additionally, while, in FIG. 2, only one motor control device is provided, two or more motor control devices can be provided in the image forming apparatus 100.

The A/D converter 153 receives a detection signal output from a thermistor 154, which detects the temperature of a fixing heater 161, converts the received detection signal from an analog signal into a digital signal, and transmits the digital signal to the system controller 151. The system controller 151 performs control of the AC driver 160 based on the digital signal received from the A/D converter 153. The AC driver 160 controls the fixing heater 161 in such a manner that the temperature of the fixing heater 161 becomes a temperature required for performing fixing processing. Furthermore, the fixing heater 161 is a heater for use in fixing processing and is included in the fixing device 318.

The system controller 151 determines whether jamming of sheets has occurred, based on detection results provided by the sheet sensors 327 and 328. Details thereof are described below.

The system controller 151 controls the operation unit 132 in such a way as to display, on a display unit provided on the operation unit 152, an operation screen which is used for the user to perform setting of, for example, the type of a recording medium to be used (hereinafter referred to as “paper type”). The system controller 151 receives information set by the user from the operation unit 152, and controls an operation sequence of the image forming apparatus 100 based on the information set by the user. Moreover, the system controller 151 transmits information indicating the status of the image forming apparatus 100 to the operation unit 152. Furthermore, the information indicating the status of the image forming apparatus 100 refers to, for example, the number of image-formed sheets, the progress status of an image forming operation, and information about, for example, jamming or double-feed of sheets in the document feeding device 201 and the image printing device 301. The operation unit 152 displays, on the display unit thereof, information received from the system controller 151.

In the above-described way, the system controller 151 controls an operation sequence of the image forming apparatus 100.

### [Motor Control Device]

Next, the motor control device 157 in the first exemplary embodiment is described. The motor control device 157 in the first exemplary embodiment is able to control a motor in any control method selected from vector control (first mode) and constant current control (second triode). Furthermore, while, in the following description, the following control is performed based on, for example, a rotation phase θ, an instructed phase θ_ref, and a phase of current, serving as electrical angles, for example, the electrical angles can be converted into mechanical angles and the following control can be performed based on the mechanical angles.

### <Vector Control>

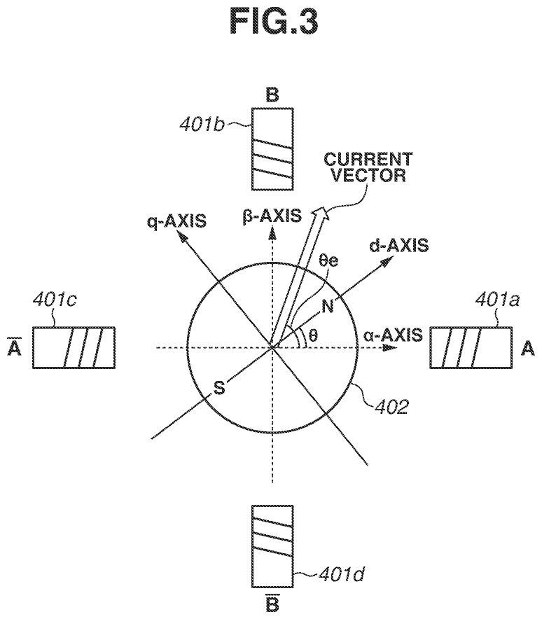

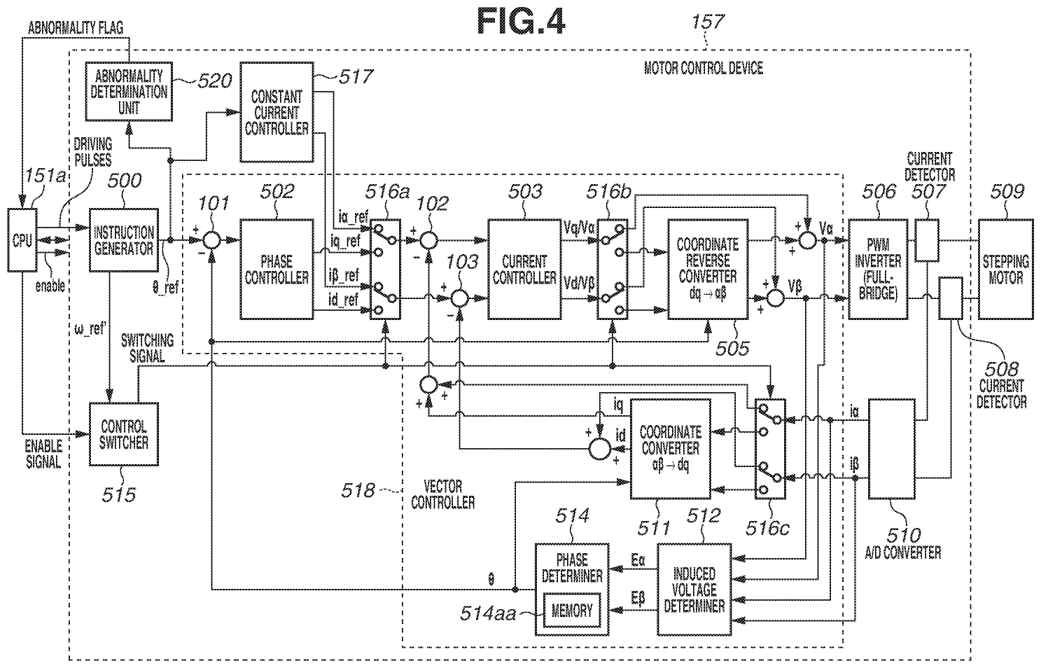

First, a method for the motor control device 157 to perform vector control in the first exemplary embodiment is described with reference to FIG. 3 and FIG. 4. Furthermore, a motor in the following description is not provided with a sensor such as a rotary encoder for detecting the rotation phase of a rotor of the motor.

FIG. 3 is a diagram illustrating a relationship between a stepping motor (hereinafter referred to as a “motor”) 509 having two phases, i.e., A-phase (first phase) and B-phase (second phase), and a rotating coordinate system expressed by a d-axis and a q-axis. In FIG. 3, in a stationary coordinate system, an α-axis, which is an axis corresponding to the winding of A-phase, and a β-axis, which is an axis corresponding to the winding of B-phase, are defined. Moreover, in FIG. 3, the d-axis is defined along the direction of a magnetic flux generated by the magnetic poles of a permanent magnet used for a rotor 402, and the q-axis is defined along a direction which has advanced 90 degrees counterclockwise from the d-axis (a direction perpendicular to the d-axis). The angle between the α-axis and the d-axis is defined as θ, and the rotation phase of the rotor 402 is expressed by the angle θ. In vector control, a rotating coordinate system that is based on the rotation phase θ of the rotor 402 is used. Specifically, in vector control, a q-axis component (torque current component) for causing the rotor to generate torque and a d-axis component (excitation current component) affecting the intensity of a magnetic flux penetrating through the winding, which are current components in the rotating coordinate system, of the current vectors corresponding to driving currents flowing through the winding are used.

The vector control is a control method which controls a motor by performing phase feedback control which controls the value of the torque current component and the value of the excitation current component in such a manner that a deviation between an instructed phase representing a target phase of the rotor and an actual rotation phase thereof becomes smaller, Moreover, the vector control can also be a control method which controls a motor by performing speed feedback control which controls the value of the torque current component and the value of the excitation current component in such a manner that a deviation between an instructed speed representing a target speed of the rotor and an actual rotational speed thereof becomes smaller.

FIG. 4 is a block diagram illustrating an example of a configuration of the motor control device 157, which controls the motor 509, Furthermore, the motor control device 157 is configured with at east one ASIC, and performs various functions which are described as follows.

As illustrated in FIG. 4, the motor control device 157 includes a constant current controller 517, which performs constant current control, and a vector controller 518, which performs vector control.

The motor control device 157 includes, as one or more circuits which perform vector control, for example, a phase controller 502, a current controller 503, a coordinate reverse converter 505, a coordinate converter 511, and a pulse width modulation (PWM) inverter 506, which supplies driving currents to the windings of the motor. The coordinate converter 511 performs coordinate conversion to convert current vectors corresponding to driving currents flowing through the windings of A-phase and B-phase of the motor 509 from a stationary coordinate system expressed by the α-axis and the β-axis into a rotating coordinate system expressed by the q-axis and the d-axis. As a result, the driving currents flowing through the windings are expressed by the current value of the q-axis component (q-axis current) and the current value of the d-axis component (d-axis current), which are current values in the rotating coordinate system. Furthermore, the q-axis current is equivalent to a torque current which causes the rotor 402 of the motor 509 to generate torque, Moreover, the d-axis current is equivalent to an excitation current which affects the intensity of a magnetic flux penetrating through the winding of the motor 509. The motor control device 157 is able to control the q-axis current and the d-axis current independently. As a result, the motor control device 157 controls the q-axis current according to a load torque applied to the rotor 402, thus being able to cause a torque required for rotating the rotor 402 to be efficiently generated. Thus, in vector control, the magnitude of a current vector illustrated in FIG. 3 varies according to the load torque applied to the rotor 402.

The motor control device 157 determines the rotation phase θ of the rotor 402 of the motor 509 by a method described below, and performs vector control based on a result of such determination. The CPU 151a outputs driving pulses as an instruction for driving the motor 509 to an instruction generator 500 based on an operation sequence of the motor 509. Furthermore, the operation sequence of the motor 509 (a drive pattern of the motor 509) is stored in, for example, the ROM 151b, and the CPU 151a outputs driving pulses as a pulse train based on the operation sequence stored in the ROM 151b.

The instruction generator 500 generates and outputs an instructed phase θ_ref, which represents a target phase of the rotor 402, based on driving pulses output from the CPU 151a. Furthermore, a configuration of the instruction generator 500 is described below.

A subtractor 101 calculates and outputs a deviation Δθ between the rotation phase θ and the instructed phase θ_ref of the rotor 402 of the motor 509.

The phase controller 502 acquires the deviation Δθ with a period T (for example, with a period of 200 μs). The phase controller 502 generates and outputs a q-axis current instructed value iq_ref and a d-axis current instructed value id_ref, in such a manner that the deviation Δθ acquired from the subtractor 101 becomes smaller, based on proportional control (P control), integral control (I control), and differential control (D control). Specifically, the phase controller 502 generates and outputs a q-axis current instructed value iq_ref and a d-axis current instructed value id_ref, in such a manner that the deviation Δθ acquired from the subtractor 101 becomes zero, based on P control, I control, and D control (PID control). Furthermore, the P control is a control method which controls the value of an object for control based on a value proportional to a deviation between the instructed value and the estimate value. Moreover, the I control is a control method which controls the value of an object for control based on a value proportional to a time integration of deviations between the instructed value and the estimate value. Moreover, the D control is a control method which controls the value of an object for control based. on a value proportional to a time variation of deviations between the instructed value and the estimate value. While the phase controller 502 in the first exemplary embodiment generates the q-axis current instructed value iq_ref and the d-axis current instructed value id_ref based on PID control, the first exemplary embodiment is not limited to this. For example, the phase controller 502 can generate the q-axis current instructed value iq_ref and the d-axis current instructed value id_ref based on P control and I control (PI control). Furthermore, while, in the first exemplary embodiment, the d-axis current instructed value id_ref, which affects the intensity of a magnetic flux penetrating through the winding, is set to θ, the first exemplary embodiment is not limited to this.

A driving current flowing through the winding of A-phase of the motor 509 is detected by a current detector 507, and is then converted by an A/D converter 510 from an analog value into a digital value. Moreover, a driving current flowing through the winding of B-phase of the motor 509 is detected by a current detector 508, and is then converted by the A/D converter 510 from an analog value into a digital value. Furthermore, the period with which the current detectors 507 and 508 detect currents is, for example, a period (for example, 25 μs) shorter than or equal to the period T with which the phase controller 502 acquires the deviation Δθ.

The current values of driving currents converted by the A/D converter 510 from analog values into digital values are expressed, as current values iα and iβ the stationary coordinate system, by the following equations (1) and (2) with use of the phase θe of the current vector illustrated in FIG. 3. Furthermore, the phase θe of the current vector is defined as an angle between the n-axis and the current vector. Moreover, I denotes the magnitude of the current rector.

iα=I*cos θe (1)

iβ=I*sin θe (2)

These current values iα and iβ are input to the coordinate converter 511 and an induced voltage determiner 512.

The coordinate converter 511 converts the current values iα and iβ in the stationary coordinate system into a current value iq of the q-axis current and a current value id of the d-axis current in the rotating coordinate system by the following equations (3) and (4).

id=cos θ*iα+sin θ*iβ (3)

iq=−sin θ*iα+cos θ*iβ (4)

The coordinate converter 511 outputs the current value iq obtained by conversion to a subtractor 102. Moreover, the coordinate converter 511 outputs the current value id obtained by conversion to a subtractor 103.

The subtractor 102 calculates a deviation between the q-axis current instructed value iq_ref and the current value iq, and outputs the calculated deviation to the current controller 503.

Moreover, the subtractor 103 calculates a deviation between the d-axis current instructed value id_ref and the current value id, and outputs the calculated deviation to the current controller 503.

The current controller 503 generates driving voltages Vq and Vd, in such a manner that the respective input deviations become smaller, based on PID control Specifically, the current controller 503 generates driving voltages Vq and Vd in such a manner that the respective input deviations become θ, and outputs the generated driving voltages Vq and Vd to the coordinate reverse converter 505. Furthermore, while the current controller 503 in the first exemplary embodiment generates the driving voltages Vq and Vd based on PID control, the first exemplary embodiment is not limited to this, For example, the current controller 503 can generate the driving voltages Vq and Vd based on PI control.

The coordinate reverse converter 505 reversely converts the driving voltages Vq and Vd in the rotating coordinate system output from the current controller 503 into driving voltages Vα and Vβ in the stationary coordinate system by the following equations (5) and (6).

Vα=cos θ*Vd−sin θ*Vq (5)

Vβ=sin θ*Vd+cos θ*Vq (6)

The coordinate reverse converter 505 outputs the driving voltages Vα and Vβ obtained by reverse conversion to the induced voltage determiner 512 and the PWM inverter 506.

The PWM inverter 506 includes a fall-bridge circuit. The full-bridge circuit is driven by pulse width modulation (PWM) signals that are based on the driving voltages Vα and Vβ input from the coordinate reverse converter 505. As a result, the PWM inverter 506 generates driving currents iα and iβ that correspond to the driving voltages Vα and Vβ, and supplies the generated driving currents iα and iβ to the windings of the respective phases of the motor 509, thus driving the motor 509. Furthermore, while, in the first exemplary embodiment, the PWM inverter 506 includes a full-bridge circuit, the PWM inverter 506 can include, for example, a half-bridge circuit.

Next, the method of determining the rotation phase θ is described. To determine the rotation phase θ of the rotor 402, the values of induced voltages Eα and Eβ which are induced at the windings of A-phase and B-phase of the motor 509 by the rotation of the rotor 402 are used. The values of induced voltages are determined (calculated) by the induced voltage determiner 512. Specifically, the induced voltages Eα and Eβ are determined by the following equations (7) and (8) from the current values iα and iβ input from the A/D converter 510 to the induced voltage determiner 512 and the driving voltages Vα and Vβ input from the coordinate reverse converter 505 to the induced voltage determiner 512.

Eα=Vα−R*iα−L*diα/dt (7)

Eβ=Vβ−R*iβ−L*diβ/dt (8)

Here, R denotes a winding resistance, and L denotes a winding inductance. The values of the winding resistance R and the winding inductance L (hereinafter referred to as “control values”) are values specific to the motor 509 being used, and are previously stored in the ROM 151b. Furthermore, the control values in the first exemplary embodiment include, for example, gain values used to determine current instructed values, such as the q-axis current instructed value iq_ref.

The induced voltages Eα and Eβ determined by the induced voltage determiner 512 are output to a phase determiner 514.

The phase determiner 514 determines the rotation phase θ of the rotor 402 of the motor 509 by the following equation (9) based on a ratio between the induced voltage Eα and the induced voltage Eβ output from the induced voltage determiner 512.

θ=tan⁻¹(−Eβ/Eα) (9)

Furthermore, while, in the first exemplary embodiment, the phase determiner 514 determines the rotation phase θ by performing calculation that is based on the equation (9), the first exemplary embodiment is not limited to this. For example, the phase determiner 514 can be configured to determine the rotation phase θ by referring to a table which is stored in, for example, the ROM 151b and which indicates a relationship between the induced voltage Eα and the induced voltage Eβ and the rotation phase θ that corresponds to the induced voltage Eα and the induced voltage Eβ.

The rotation phase θ of the rotor 402 obtained in the above-described way is input to the subtractor 101, the coordinate reverse converter 505, and the coordinate converter 511.

When performing vector control, the motor control device 157 repetitively performs the above-described control.

As described above, the motor control device 157 in the first exemplary embodiment performs vector control using phase feedback control which controls current values in the rotating coordinate system in such a manner that a deviation between the instructed phase θ_ref and the rotation phase θ becomes smaller. Performing vector control allows preventing or reducing an increase in motor sound and an increase in power consumption caused by extra torque. Moreover, feeding back the rotation phase allows performing control in such a manner that the rotation phase of the rotor becomes a predetermined phase. Accordingly, vector control using phase feedback control is applied to a motor which drives a load (for example, a registration roller) the rotation phase of which is required to be controlled with a high degree of accuracy to appropriately perform image formation on a recording medium. As a result, image formation on a recording medium can be appropriately performed.

### <Constant Current Control>

Next, constant current control in the first exemplary embodiment is described.

In constant current control, a previously determined current is supplied to the winding of a motor, so that a driving current flowing through the winding is controlled. Specifically, in constant current control, in order that step-out of the motor does not occur even if the load torque applied to the rotor varies, a driving current having the magnitude (amplitude) that corresponds to a torque obtained by adding a predetermined margin to a torque supposed to be required for the rotation of the rotor is supplied to the winding. This is because, since, in constant current control, a configuration in which the magnitude of a driving current is controlled based on the determined (estimated. rotation phase or rotational speed is not used (feedback control is not performed), it is impossible or at least not possible to adjust the driving current according to a load torque applied to the rotor. Furthermore, as the magnitude of the current is larger, the torque applied to the rotor becomes larger. Moreover, the amplitude corresponds to the magnitude of the current vector.

While, in the following description, during constant current control, the motor is controlled by a current having a previously determined given magnitude being supplied to the winding of the motor, the first exemplary embodiment is not limited to this. For example, during constant current control, the motor can be controlled by a current having a magnitude previously determined according to the acceleration of the motor in process and the deceleration of the motor in process being supplied to the winding of the motor.

Referring to FIG. 4, the instruction generator 500 outputs the instructed phase θ_ref to the constant current controller 517 based on driving pulses output from the CPU 151a. The constant current controller 517 generates and outputs instructed values iα_ref and iβ_ref for currents in the stationary coordinate system, which correspond to the instructed phase θ_ref output from the instruction generator 500. Furthermore, in the first exemplary embodiment, the magnitude of the current vector corresponding to the instructed values iα_ref and iβ_ref for currents in the stationary coordinate system is always constant.

The driving currents flowing through the windings of A-phase and B-phase of the motor 509 are detected by the current detectors 507 and 508. Each of the detected driving currents is converted by the A/D converter 510 from an analog value into a digital value, as mentioned above.

The subtractor 102 receives, as inputs, the current value in output from the A/D converter 510 and the current instructed value iα_ref output from the constant current controller 517. The subtractor 102 calculates a deviation between the current instructed value iα_ref and the current value iα, and outputs the calculated. deviation to the current controller 503.

Moreover, the subtractor 103 receives, as inputs, the current value iβ output from the A/D converter 510 and the current instructed value output from the constant current controller 517, The subtractor 103 calculates a deviation between the current instructed value iβ_ref and the current value iβ, and outputs the calculated deviation to the current controller 503.

The current controller 503 outputs driving voltages Vα and Vβ based on PID control in such a manner that the input deviation becomes smaller. Specifically, the current controller 503 outputs the driving voltages Vα and Vβ in such a manner that the input deviation comes close to 0.

The PWM inverter 506 supplies driving currents to the windings of the respective phases of the motor 509 based on the input driving voltages Vα and Vβ by the above-mentioned method, thus driving the motor 509.

In this way, in constant current control in the first exemplary embodiment, neither phase feedback control nor speed feedback control is performed. In other words, in constant current control in the first exemplary embodiment, the driving currents to be supplied to the windings are not adjusted according to the rotation status of the rotor. Accordingly, in constant current control, in order that step-out of the motor does not occur, a current obtained by adding a predetermined margin to a current required for rotating the rotor is supplied to the winding.

### <Instruction Generator>

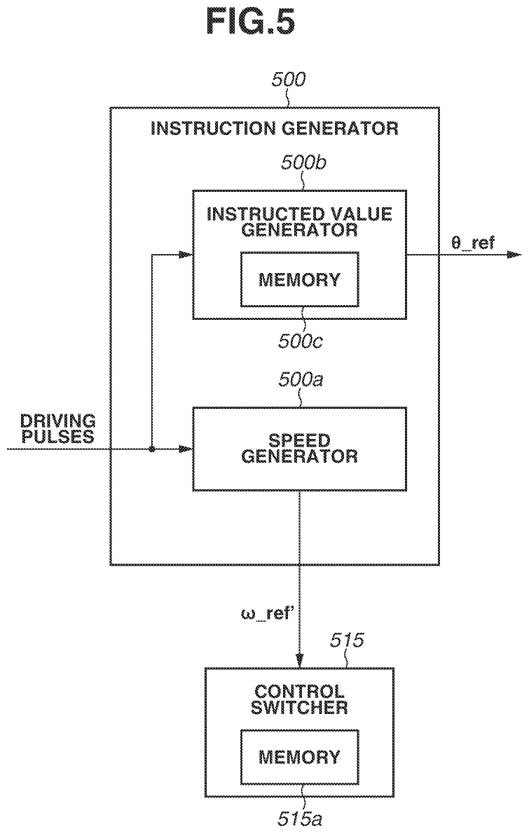

FIG. 5 is a block diagram illustrating a configuration of the instruction generator 500 in the first exemplary embodiment. As illustrated in FIG. 5, the instruction generator 500 includes a speed generator 500a, which serves as a speed determination unit for generating a rotational speed ω_ref′ as a substitute for a instructed speed, and a instructed value generator 500b, which generates a instructed phase θ_ref based on driving pulses output from the CPU 151a.

The speed generator 500a generates and outputs the rotational speed ω_ref′ based on the time interval of falling edges of continuous driving pulses. Thus, the rotational speed ω_ref′ varies with a period corresponding to the period of driving pulses.

The instructed value generator 500b generates and outputs the instructed phase θ_ref in the way expressed by the following equation (10) based on driving pulses output from the CPU 151a.

θ_ref=θini+θstep*n (10)

Furthermore, θini is the phase of the rotor obtained when driving of the motor is started (initial phase). Moreover, θstep is the increased amount (amount of change) of instructed phase θ_ref per one driving pulse. Moreover, n is the number of pulses which are input to the instructed value generator 500b.

### {Micro-Step Drive System}

in the first exemplary embodiment, in constant current control, a micro-step drive system is used. Furthermore, the drive method for use in constant current control is not limited to the micro-step drive system, but can be, for example, another drive method such as a full-step drive system.

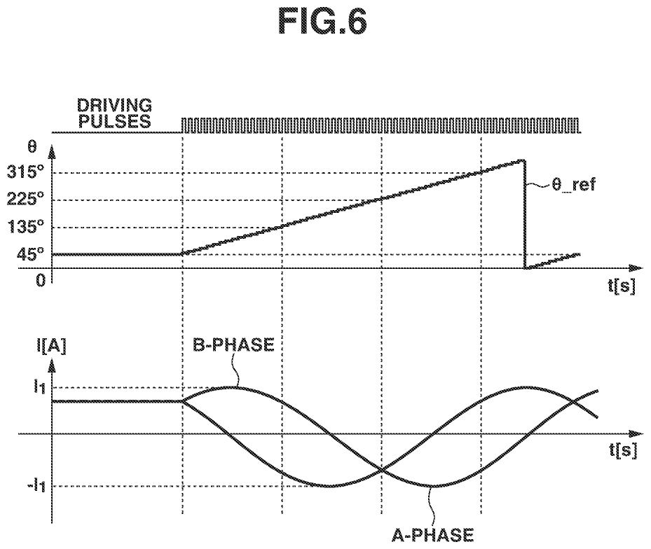

FIG. 6 is a diagram illustrating an example of a method of performing the micro-step drive system. In FIG. 6, driving pulses which are output from the CPU 151a, the instructed phase θ_ref which is generated by the instructed value generator 500b, and currents which flow through the windings of A-phase and B-phase are illustrated.

In the following description, the method of performing micro-step drive in the first exemplary embodiment is described with reference to FIG. 5 and FIG. 6. Furthermore, the driving pulses and the instructed phase illustrated in FIG. 6 indicate the state in which the rotor is rotating at a constant speed.

The advance amount of the instructed phase θ_ref in the micro-step drive system is an amount (90°/N) obtained by dividing 90°, which is the advance amount of the instructed phase θ_ref in the fill-step drive system, by N (N being a positive integer number). As a result, current waveforms vary smoothly in a sine wave form as illustrated in FIG. 6, so that the rotation phase θ of the rotor can be controlled more finely.

When the micro-step drive is performed, the instructed value generator 500b generates and outputs the instructed phase θ_ref in the way expressed by the following equation (11) based on driving pulses output from the CPU 151a.

θ_ref=45°+90/N°*n (11)

In this way, when receiving one driving pulse as an input, the instructed value generator 500b adds 90/N° to the instructed phase θ_ref, thus updating the instructed phase θ_ref. Thus, the number of driving pulses which are output from the CPU 151a corresponds to the instructed phase. Furthermore, the period (frequency) of driving pulses which are output from the CPU 151a corresponds to the target speed (instructed speed) of the motor 509.

### <Switching Between Vector Control and Constant Current Control>

Next, a method of switching between constant current control and vector control is described. As illustrated in FIG. 4, the motor control device 157 in the first exemplary embodiment includes a configuration which switches between constant current control and vector control. Specifically, the motor control device 157 includes a control switcher 515 and changeover switches 516a and 516b. Furthermore, during a period in which constant current control is being performed, one or more circuits which perform vector control can be operating or can be at a stop. Moreover, during a period in which vector control is being performed, circuits which perform constant current control can be operating or can be at a stop.

As illustrated in FIG. 5, the rotational speed ω_ref output from the speed generator 500a is input to the control switcher 515. The control switcher 515 makes a comparison between the rotational speed ω_ref′ and a threshold value ωth serving as a predetermined value, and switches the control method for the motor from constant current control to vector control.

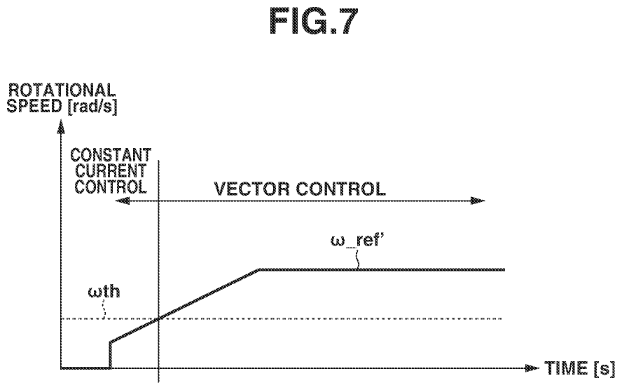

FIG. 7 is a diagram used to explain switching of the control method for the motor. Furthermore, while the threshold value ωth in the first exemplary embodiment is set to the lowest rotational speed out of rotational speeds according to which the rotation phase θ is determined with a high degree of accuracy, the first exemplary embodiment is not limited to this. For example, the threshold value ωth can be set to a value greater than or equal to the lowest rotational speed out of rotational speeds according to which the rotation phase θ is determined with a high degree of accuracy, Moreover, the threshold value ωth is previously stored in a memory 515a provided in the control switcher 515.

In a case where, during operation of the constant current controller 517, the rotational speed ω_ref is smaller than the threshold value ωth (ω_ref′<ωth), the control switcher 515 does not perform switching of controllers which control the motor 509. Thus, the control switcher 515 outputs a switching signal in such a way as to maintain the state in which the motor 509 is controlled by the constant current controller 517. As a result, the states of the changeover switches 516a, 516b, and 516c are maintained, so that constant current control performed by the constant current controller 517 is continued.

Moreover, when, during operation of the constant current controller 517, the rotational speed ω_ref′ becomes greater than or equal to the threshold value ωth (ω_ref′≥ωth), the control switcher 515 switches controllers which control the motor 509. Thus, the control switcher 515 outputs a switching signal in such a way as to switch the controller which controls the motor 509 from the constant current controller 517 to the vector controller 518. As a result, the states of the changeover switches 516a, 516b, and 516c are switched according to the switching signal, so that vector control is performed by the vector controller 518.

When, during operation of the vector controller 518, the rotational speed ω_ref′ becomes smaller than the threshold value ωth (ω_ref′<ωth), the control switcher 515 switches controllers which control the motor 509. Thus, the control switcher 515 outputs a switching signal in such a way as to switch the controller which controls the motor 509 from the vector controller 518 to the constant current controller 517. As a result, the states of the changeover switches 516a, 516b, and 516c are switched according to the switching signal, so that constant current control is performed by the constant current controller 517.

Moreover, in a case where, during operation of the vector controller 518, the rotational speed ω_ref is greater than or equal to the threshold value ω_ref′≥ωth), the control switcher 515 does not perform switching of controllers which control the motor 509. Thus, the control switcher 515 outputs a switching signal in such a way as to maintain the state in which the motor 509 is controlled by the vector controller 518. As a result, the states of the changeover switches 516a, 516b, and 516c are maintained, so that vector control performed by the vector controller 518 is continued.

As illustrated in FIG. 4, in the first exemplary embodiment, an enable signal for allowing execution of vector control is output from the CPU 151a to the motor control device 157.

In a case where the enable signal is “0”, the motor control device 157 is inhibited from performing vector control. In other words, in a case where the enable signal is “0”, the motor control device 157 does not perform the above-mentioned switching of control but performs control of the motor by constant current control during a period from when the motor is driven to when the motor is stopped.

On the other hand, in a case where the enable signal is “1”, the motor control device 157 is allowed to perform execution of vector control. In other words, in a case where the enable signal is “1”, the motor control device 157 performs the above-mentioned switching of control.

### [Step-Out of Motor]

In the first exemplary embodiment, the rotation phase θ of the rotor 402 of the motor 509 is determined based on a control value that is a value specific to the motor 509. For example, in a case where a motor which differs in type from the motor 509 is mounted to the motor control device 157, the following issues may arise. Specifically, due to a control value which corresponds to the motor 509 different from the motor being previously set, it may become impossible or at least not possible to determine the rotation phase θ of the rotor of the motor with a high degree of accuracy. As a result, vector control may be performed based on the rotation phase θ different from the actual rotation phase of the rotor, so that control of the motor may become unstable and step-out of the motor may occur.

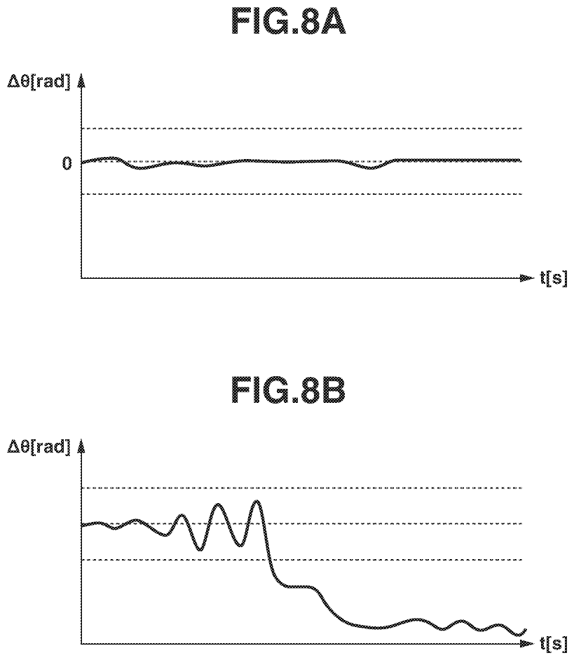

FIGS. 8A and 8B are diagrams illustrating examples of a deviation Δθ between the instructed phase θ_ref and the rotation phase θ. FIG. 8A is a diagram illustrating the deviation Δθ obtained in a case where a control value corresponding to a control target motor is set as a control value for determining the rotation phase θ. FIG. 8B is a diagram illustrating the deviation Δθ obtained in a case where a control value corresponding to a motor which differs in type from the control target motor is set as a control value for determining the rotation phase θ.

As illustrated in FIG. 8A, in a case where a control value corresponding to a control target motor is set as a control value for determining the rotation phase θ, the deviation Δθobtained during the process of control of the motor takes values within a predetermined range. Furthermore, the predetermined range is set, for example, in such a manner that, in a case where a control value corresponding to a control target motor is set as a control value for determining the rotation phase θ, a deviation Δθ which varies in the state in which the control target motor is normally driven does not exceed the predetermined range.

On the other hand, as illustrated in FIG. 8B, in a case where a control value corresponding to a motor which differs in type from the control target motor is set as a control value for determining the rotation phase θ, the deviation Δθ would take values outside the predetermined range. This occurs due to the following reason. Specifically, for example, in a case where the rotation phase θ as determined is a phase faster than the actual rotation phase of the rotor, the motor rotates while receiving a torque smaller than a load torque applied to the rotor. As a result, the rotational speed of the rotor decreases and the induced voltage generated at the winding of the motor becomes gradually smaller, so that the accuracy of determining the rotation phase θ decreases (the values of the rotation phase θ vary). As a result, control of the motor becomes unstable, and step-out of the motor may occur.

Even if vector control is performed after the occurrence of step-out of the motor, step-out of the motor may occur again. Therefore, in the first exemplary embodiment, applying the following configuration allows preventing or reducing an abnormality of rotation of the motor from repetitively occurring. input to an abnormality determination unit 520. The abnormality determination unit 520 sets an abnormality flag from “0” to “1” when the deviation Δθ becomes a value outside the predetermined range. Furthermore, the state in which the rotation of the motor is abnormal includes not only step-out of the motor but also states such as a locked state of the stator or a decrease of the rotational speed caused by, for example, external force.

### [Driving Sequence of Motor]

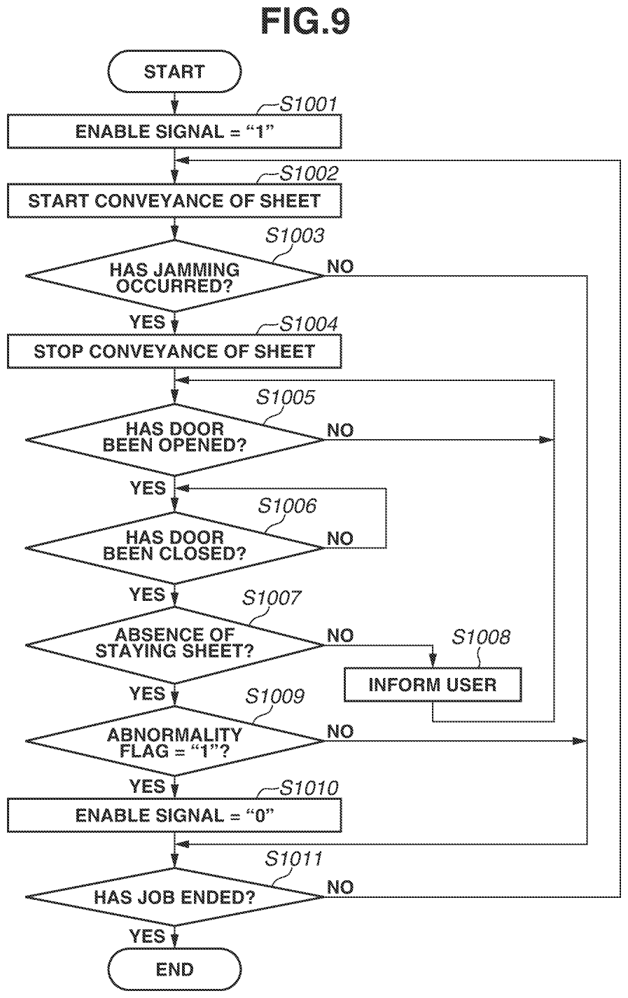

FIG. 9 is a flowchart illustrating a control method for the motor in the first exemplary embodiment. Processing in the flowchart of FIG. 9 is performed by the CPU 151a. Furthermore, during processing in the flowchart of FIG. 9, the abnormality determination unit 520 performs the above-mentioned abnormality determination for the motor and sets the abnormality flag from “0” to “1” when the deviation Δθ becomes a value outside the predetermined range. When the processing in the flowchart of FIG. 9 ends, the abnormality flag is reset (set to “0”).

In step S1001, the CPU 151a sets the enable signal to “1”, and, in step S1002, the CPU 151a starts conveyance of a sheet.

Next, if, in step S1003, it is determined that jamming of a sheet has occurred (YES in step S1003), then in step S1004, the CPU 151a stops conveyance of a sheet. Furthermore, the CPU 151a performs the following method to determine whether jamming of a sheet has occurred. Specifically, for example, in a case where, even after a predetermined time elapses after the leading edge of a sheet is detected by the sheet sensor 7, the leading edge of the sheet is not detected by the sheet sensor 328, the CPU 151a determines that jamming of a sheet (delay jamming) has occurred. Moreover, for example, when the state in which the sheet sensor 327 is detecting a sheet continues for a second predetermined time, the CPU 151a determines that jamming of a sheet (stay jamming) has occurred. In this way, the CPU 151a determines whether jamming of a sheet has occurred based on results of detection performed by the sheet sensors provided in the conveyance path.

On the other hand, if, in step S1003, it is determined that jamming of a sheet has not occurred (NO in step S1003), the CPU 151a advances the processing to step S1011.

If, in step S1005, it is detected by the door sensor 330 that the door 329 has been opened (YES in step S1005), the CPU 151a advances the processing to step S1006.

Next, if, in step S1006, it is detected by the door sensor 330 that the door 329 has been closed (YES in step S1006), the CPU 151a advances the processing to step S1007.

If, in step S1007, it is determined that a sheet is staying in the conveyance path used for a sheet to be conveyed (NO in step S1007), then in step S1008, the CPU 151a notifies the user that a sheet is staying in the conveyance path, by displaying that effect on the display unit of the operation unit 152, and then returns the processing to step S1005. Furthermore, detection of a staying sheet is performed, for example, based on a result of detection performed by a sheet sensor provided in the conveyance path.

On the other hand, if, in step S1007, it is determined that no sheet is staying in the conveyance path used for a sheet to be conveyed (YES in step S1007), the CPU 151a advances the processing to step S1009.

If, in step S1009, it is determined that the abnormality flag is “1” (YES in step S1009), then in step S1010, the CPU 151a sets the enable signal to “0”.

On the other hand, if, in step S1009, it is determined that the abnormality flag is “0” (NO in step S1009), the CPU 151a advances the processing to step S1011.

If, in step S1011, it is determined that the print job has not ended (NO in step S1011), the CPU 151a returns the processing to step S1002. On the other hand, if, in step S1011, it is determined that the print job has ended (YES in step S1011), the CPU 151a ends the processing in the flowchart of FIG. 9.

As mentioned above, in the first exemplary embodiment, in a case where jamming of a sheet has not occurred, the enable signal is set to “1”. As a result, the motor control device 157 starts driving of the motor by constant current control, and, after that, when the rotational speed ω_ref′ becomes greater than or equal to the threshold value ωth, the motor control device 157 switches the control method from constant current control to vector control.

On the other hand, in a case where jamming of a sheet has occurred, the CPU 151a checks whether the rotation of the motor mounted to the motor control device 157 is abnormal. Then, in a case where the abnormality flag is “1”, the enable signal is set to “0”. As a result, the motor control device 157 starts driving of the motor by constant current control, and, after that, even if the rotational speed ω_ref′ becomes greater than or equal to the threshold value ωth, the motor control device 157 maintains constant current control. In other words, the motor control device 157 does not perform switching from constant current control to vector control. Moreover, in a case where the abnormality flag is “0”, the enable signal is set to “1”.

In this way, in the first exemplary embodiment, when it is detected that the rotation of the motor is abnormal, the motor control device 157 starts driving of the motor by constant current control, and, after that, even if the rotational speed ω_ref′ becomes greater than or equal to the threshold value ωth, the motor control device 157 maintains constant current control. As a result, it is possible to prevent or reduce an abnormality of the rotation of the motor from repetitively occurring due to vector control being performed in the state in which control values set in the motor control device 157 are different from control values corresponding to the motor mounted to the motor control device 157.

In a second exemplary embodiment, portions which have similar configurations to the configurations of the first exemplary embodiment are omitted from description here.

In the second exemplary embodiment, as the motor 509, a motor A or a motor B which differs in type from the motor A is able to be mounted to the image forming apparatus 100, in the second exemplary embodiment, as the control values used for determining the induced voltages Eα and Eβ, control values corresponding to the motor A and control values corresponding to the motor B are previously stored in the ROM 151b. The CPU 151a sets either the control values corresponding to the motor A or the control values corresponding to the motor B based on the type of a motor mounted to the image forming apparatus 100, as the values used for determining the induced voltages Eα and Eβ.

### [Method of Discriminating Between Types of Motors]

As mentioned above, in the second exemplary embodiment, as the motor 509, a motor A or a motor B which differs in type from the motor A is able to be mounted to the image forming apparatus 100. Therefore, the image forming apparatus 100 in the second exemplary embodiment includes a configuration which discriminates the type of a motor mounted to the motor control device 157. When an instruction to discriminate the type of a motor is received from, for example, the user, the CPU 151a starts processing for discriminating the type of a motor.

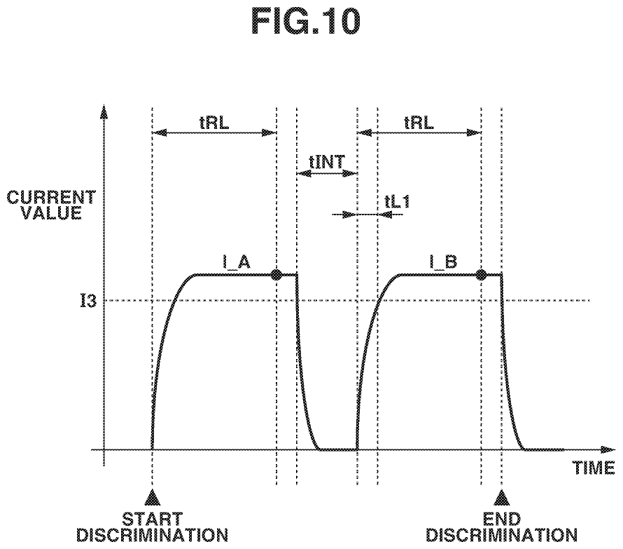

FIG. 10 is a diagram used to explain the method of discriminating the type of a motor. Upon starting processing for discriminating the type of a motor, the CPU 151a controls the motor control device 157 in such a way as to apply a predetermined voltage E to the winding of the motor 509. Then, after the elapse of a predetermined time tRL, the CPU 151a performs sampling of a current flowing through the winding. Furthermore, the predetermined time tRL is set to a time longer than a time required from when the predetermined voltage E is applied to the winding to when the influence of transient response of a current which rises due to the predetermined voltage E becomes relatively small and an almost constant current becomes flowing through the winding.

After performing sampling of the current the CPU 151a controls the motor control device 157 in such a way as to stop the predetermined voltage E from being applied to the winding. Then, after the elapse of a predetermined time tINT, the CPU 151a controls the motor control device 157 in such a way as to apply the predetermined voltage E to the winding of the motor 509. Furthermore, the predetermined time tINT is set to a time longer than a time required until a current flowing through the winding due to the predetermined voltage E becomes approximately 0 A.

Then, the CPU 151a measures a time tL1 from when, after the elapse of the predetermined time tINT, the predetermined voltage E is applied to the winding to when a current flowing through the winding becomes a predetermined current I3. Moreover, after the elapse of the predetermined time tRL after the predetermined voltage E is applied. to the winding after the elapse of the predetermined time tINT, the CPU 151a performs sampling of a current I_B.

The CPU 151a estimates an inductance L of the winding based on the detected currents I_A and I_B and the measured time tL1, Specifically, the CPU 151a estimates the inductance L based on the following equations (12) to (17).

R_A=E/I_A (12)

R_B=E/I_B (13)

R=(R_A+R_B)/2 (14)

L_A=R_*tL1*K (15)

L_B=R_B*tL1*K (16)

L=(L_A+L_B)/2 (17)

Furthermore, the coefficient K is a coefficient representing a relationship between a resistance value and an inductance value.

In a case where the inductance L is less than or equal to a threshold value Lth, the CPU 151a determines that the motor mounted to the motor control device 157 is the motor A, and sets the control values in the motor control device 157 to the control values corresponding to the motor A.

Moreover, in a case where the inductance L is greater than the threshold value Lth, the CPU 151a determines that the motor mounted to the motor control device 157 is the motor B, and sets the control values in the motor control device 157 to the control values corresponding to the motor B.

Furthermore, the above-mentioned method of estimating the resistance values R and the inductances L is merely an example in the second exemplary embodiment, and the second exemplary embodiment is not limited to this.

As mentioned above, in the second exemplary embodiment, when an instruction to discriminate the type of a motor is input from, for example, the user, the CPU 151a starts processing for discriminating the type of a motor. For example, even when an instruction to discriminate the type of a motor is input and processing for discriminating the type of a motor is started, in a case where a motor C which differs in type from the motor A and the motor B has been mounted to the motor control device 157, the following issues may arise. Specifically, notwithstanding that the motor mounted to the motor control device 157 is the motor C, it may be erroneously determined that the motor mounted to the motor control device 157 is the motor A. As a result, vector control may be performed in the state in which the control values corresponding to the motor mounted to the motor control device 157 differ from the control values set in the motor control device 157. Moreover, for example, in a case where, when motors have been replaced, the user has not input an instruction to discriminate the type of a motor, vector control may be performed in the state in which the control values corresponding to the motor mounted to the motor control device 157 differ from the control values set in the motor control device 157. As a result, due to the reason that it becomes impossible or at least not possible to determine the rotation phase of the rotor of the motor with a high degree of accuracy, control of the motor may become unstable and step-out of the motor may occur. In this case, even if vector control is performed after the occurrence of step-out of the motor, step-out of the motor may occur again.

Therefore, in the second exemplary embodiment, applying the following configuration allows preventing or reducing an abnormality of rotation of the motor from repetitively occurring.

### [Driving Sequence of Motor]

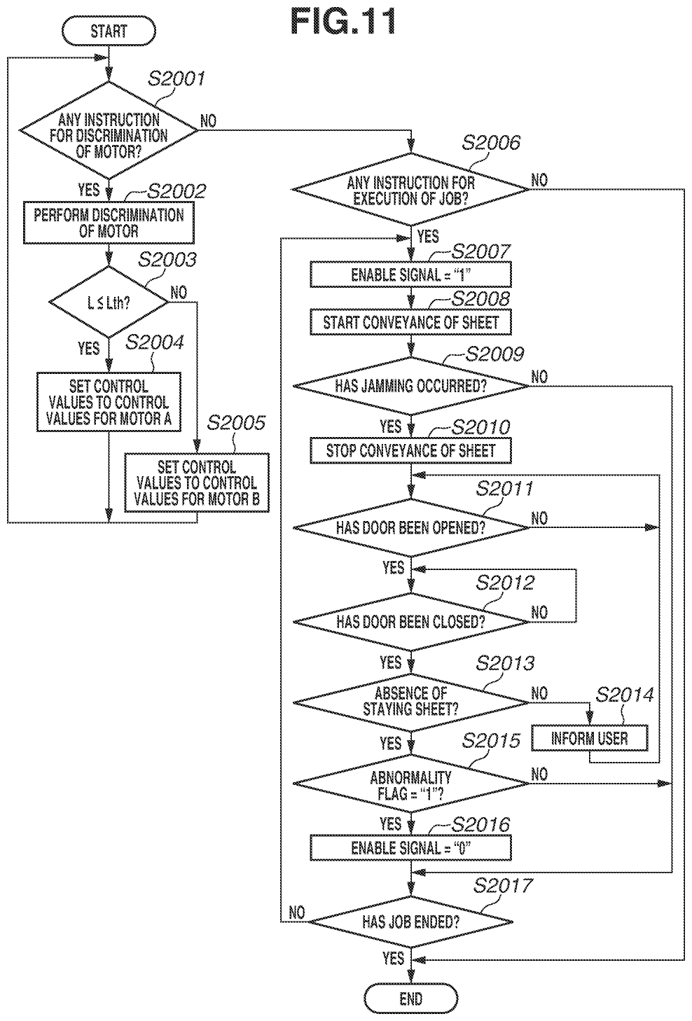

FIG. 11 is a flowchart illustrating a control method for the motor in the second exemplary embodiment. Processing in the flowchart of FIG. 11 is performed by the CPU 151a. Furthermore, during processing in the flowchart of FIG. 11, the abnormality determination unit 520 performs the above-mentioned abnormality determination for the motor and sets the abnormality flag from “0” to “1” when the deviation Δθ becomes a value outside the predetermined range. When the processing in the flowchart of FIG. 11 ends, the abnormality flag is reset (set to “0”).

If, in step S2001, it is determined that an instruction to discriminate the type of a motor mounted to the motor control device 157 has been input via the operation unit 152 (YES in step S2001), then in step S2002, the CPU 151a performs processing for discriminating the type of the motor by the method described with reference to FIG. 10.

If, in step S2003, it is determined that the inductance value L detected by the discrimination processing is less than or equal to the threshold value Lth (YES in step S2003), then in step S2004, the CPU 151a sets the control values used for vector control to the control values corresponding to the motor A.

On the other hand, if, in step S2003, it is determined that the inductance value L detected by the discrimination processing is greater than the threshold value Lth (NO in step S2003), then in step S2005, the CPU 151a sets the control values used for sector control to the control values corresponding to the motor B.

Moreover, if, in step S2001, it is determined that no instruction to discriminate the type of a motor mounted to the motor control device 157 has been input (NO in step S2001), the CPU 151a advances the processing to step S2006.

If, in step S2006, it is determined that an instruction to execute a print job has been input via the operation unit 152 (YES in step S2006), then in step S2007, the CPU 151a sets the enable signal to “1”, and then in step S2008, the CPU 151a starts conveyance of a sheet.

Next, if, in step S2009, it is determined that jamming of a sheet has occurred (YES in step S2009), then in step S2010, the CPU 151a stops conveyance of a sheet.

On the other hand, if, in step S2009, it is determined that jamming of a sheet has not occurred (NO in step S2009), the CPU 151a advances the processing to step S2017.

If, in step S2011, it is detected by the door sensor 330 that the door 329 has been opened (YES in step S2011), the CPU 151a advances the processing to step S2012.

Next, if, in step S2012, it is detected by the door sensor 330 that the door 329 has been closed (YES in step S2012), the CPU 151a advances the processing to step S2013.

If, in step S2013, it is determined that a sheet is staying in the conveyance path used for a sheet to be conveyed (NO in step S2013), then in step S2014, the CPU 151a notifies the user that a sheet is staying in the conveyance path, by displaying that effect on the display unit of the operation unit 152, and then returns the processing to step S2011.

On the other hand, if, in step S2013, it is determined that no sheet is staying in the conveyance path used for a sheet to be conveyed (YES in step S2013), the CPU 151a advances the processing to step S2015.

If, in step S2015, it is determined that the abnormality flag is “1” (YES in step S2015), then in step S2016, the CPU 151a sets the enable signal to “0”.

On the other hand, if, in step S2015, it is determined that the abnormality flag is “0” (NO in step S2015), the CPU 151a advances the processing to step S2017.

If, in step S2017, it is determined that the print job has not ended (NO in step S2017), the CPU 151a returns the processing to step S2007. On the other hand, if, in step S2017, it is determined that the print job has ended (YES in step S2017), the CPU 151a ends the processing in the flowchart of FIG. 11.

As mentioned above, in the second exemplary embodiment, when an instruction to discriminate the type of a motor mounted to the motor control device 157 is input to the CPU 151a, the CPU 151a performs processing for discriminating the type of the motor. The CPU 151a sets control values in the motor control device 157 based on a result of such processing. As a result, it is possible to reduce an error between the rotation phase θ which is determined by the phase determiner 514 in vector control and the actual rotation phase of the rotor, so that the occurrence of step-out of the motor in vector control can be prevented or reduced.

Moreover, in the second. exemplary embodiment, in a case where jamming of a sheet has not occurred, the enable signal is set to “1”. As a result, the motor control device 157 starts driving of the motor by constant current control, and, after that, when the rotational speed ω_ref′ becomes greater than or equal to the threshold value ωth, the motor control device 157 switches the control method from constant current control to vector control.

On the other hand, in a case where jamming of a sheet has occurred, the CPU 151a checks whether the rotation of the motor mounted to the motor control device 157 is abnormal. Then, in a case where the abnormality flag is “1”, the enable signal is set to “0”. As a result, the motor control device 157 starts driving of the motor by constant current control, and, after that, even if the rotational speed ω_ref′ becomes greater than or equal to the threshold value ωth, the motor control device 157 maintains constant current control. In other words, the motor control device 157 does not perform switching from constant current control to vector control. Moreover, in a case where the abnormality flag is “0”, the enable signal is set to “1”.

In this way, in the second exemplary embodiment, when it is detected that the rotation of the motor is abnormal, the motor control device 157 starts driving of the motor by constant current control, and, after that, even if the rotational speed ω_ref′ becomes greater than or equal to the threshold value ωth, the motor control device 157 maintains constant current control. As a result, it is possible to prevent or reduce an abnormality of the rotation of the motor from repetitively occurring due to vector control being performed in the state in which control values set in the motor control device 157 are different from control values corresponding to the motor mounted to the motor control device 157.

Furthermore, in the second exemplary embodiment, for example, at the time of factory shipment, the motor A is mounted to the image forming apparatus 100, and control values in the motor control device 157 are set to control values corresponding to the motor A.

Furthermore, while, in the first exemplary embodiment and the second exemplary embodiment, when the abnormality flag is “1”, the CPU 151a controls the motor control device 157 in such a way as not to switch the method of controlling the motor mounted to the motor control device 157 from constant current control to vector control, the first and second exemplary embodiments are not limited to this. For example, a configuration in which, when jamming of a sheet occurs, the CPU 151a controls the motor control device 157 in such a way as not to switch from constant current control to vector control regardless of the abnormality flag can be employed.

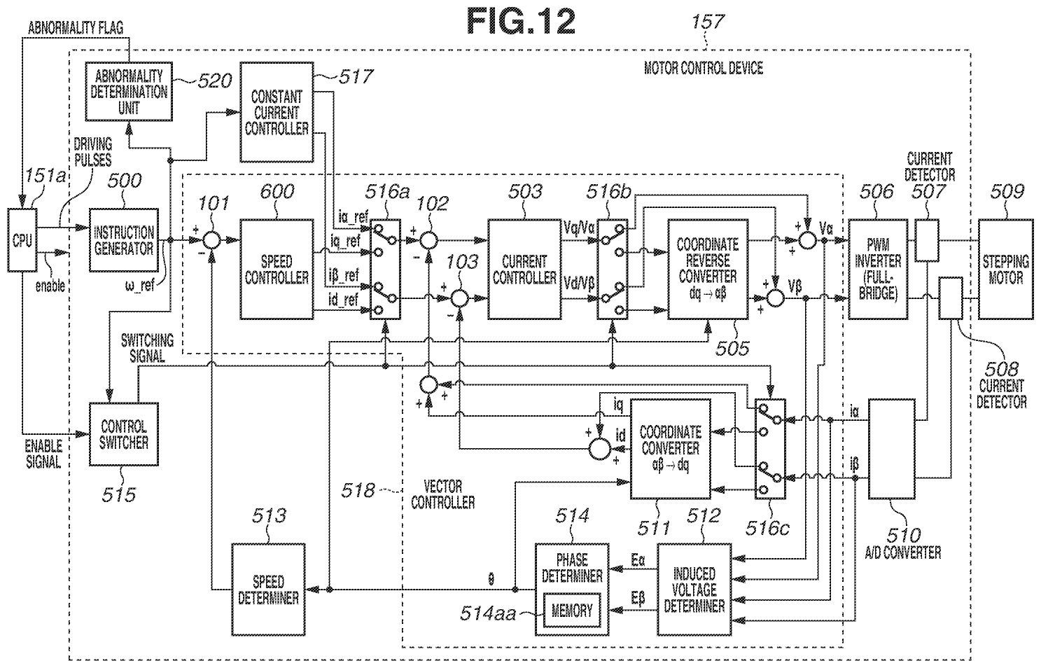

Moreover, while, in vector control in the first exemplary embodiment and the second exemplary embodiment, the CPU 151a controls the motor by performing phase feedback control, the first and second exemplary embodiments are not limited to this. For example, a configuration in which the CPU 151a controls the motor by feeding back the rotational speed ω of the rotor 402 can be employed. Specifically, as illustrated in FIG. 12, a speed determiner 513 is provided inside the motor control device 157, and the speed determiner 513 determines the rotational speed co based on a temporal change of the rotation phase θ output from the phase determiner 514. Furthermore, the following equation (18) is assumed to be used to determine the rotational speed ω.

ω=dθ/dt (18)

Then, the CPU 151a outputs the instructed speed ω_ref representing a target speed of the rotor. Additionally, a speed controller 600 is provided inside the motor control device 157, and the speed controller 600 is configured to generate and output the q-axis current instructed value iq_ref and the d-axis current instructed value id_ref in such a manner that a deviation between the rotational speed ω and the instructed speed ω_ref becomes smaller. Thus, a configuration which controls the motor by performing such speed feedback control can be employed. In the case of such a configuration, abnormality detection is performed based on a deviation Δω between the rotational speed ω and the instructed speed ω_ref.

In a third exemplary embodiment, portions which have similar configurations to the configurations of the second exemplary embodiment are omitted from description here.

In the above-described second exemplary embodiment, when the inductance L is less than or equal to the threshold value Lth, the CPU 151a determines that the motor mounted to the motor control device 157 is the motor A. Moreover, when the inductance L is greater than the threshold value Lth, the CPU 151a determines that the motor mounted to the motor control device 157 is the motor B. In the third exemplary embodiment, the type of a motor is discriminated in the following way.

Specifically, when the estimated resistance value R and inductance L satisfy the following inequalities (19), the CPU 151a determines that the motor mounted to the motor control device 157 is the motor A, and sets the control values in the motor control device 157 to control values corresponding to the motor A.

R1≤R≤R2, L1≤L≤L2 (19)

Moreover, when the estimated resistance value R and inductance L satisfy the following inequalities (20), the CPU 151a determines that the motor mounted to the motor control device 157 is the motor B, and sets the control values in the motor control device 157 to control values corresponding to the motor B.

R3≤R≤R4, L3≤L≤L4 (20)

Moreover, when the estimated resistance value R and inductance L satisfy neither of the above-mentioned inequalities (19) and (20), the CPU 151a determines that the motor mounted to the motor control device 157 is a motor C which is different from the motor A and the motor b. Then, the CPU 151a notifies the user by displaying information indicating that the motor C has been mounted to the motor control device 157 on the display unit of the operation unit 152, thus prompting the user to replace motors.

In this way, in the third exemplary embodiment, if it is determined by motor discrimination processing that a motor C different from the motor A and the motor B is mounted to the motor control device 157, the CPU 151a displays, on the display unit, information indicating that the motor C has been mounted to the motor control device 157, thus prompting the user to replace motors. As a result, it is possible to prevent or reduce a motor C different from the motor A and the motor B from being driven by vector control. In other words, it is possible to prevent or reduce step-out of the motor from occurring due to vector control being performed in the state in which the control values corresponding to the motor mounted to the motor control device 157 are different from the control values set in the motor control device 157.

Additionally, in the third exemplary embodiment, when it is determined that the motor mounted to the motor control device 157 is the motor C, the CPU 151a controls the motor control device 157 in such a way as not to perform switching from constant current control to vector control. As a result, it is possible to prevent or reduce an abnormality of the motor from repetitively occurring due to vector control being performed in the state in which the control values set in the motor control device 157 are different from the control values corresponding to the motor mounted to the motor control device 157. Moreover, it is possible to prevent a situation in which the image forming apparatus 100 is not able to operate until the motor C is replaced. Thus, it is possible to prevent or reduce a downtime from occurring in the image forming apparatus 100.

Furthermore, while, in the second exemplary embodiment and the third exemplary embodiment, the resistance value R and the inductance L of the winding of a motor are measured by the method illustrated in FIG. 10 and the type of the motor is discriminated based on a result of such measurement, the second exemplary embodiment and the third exemplary embodiment are not limited to this. For example, a configuration in which a barcode is provided on a motor and the type of the motor is discriminated by the motor control device 157 reading the barcode can be employed.

In a fourth exemplary embodiment, portions which have similar configurations to the configurations of the first exemplary embodiment are omitted from description here.

In the above-described first exemplary embodiment, when the rotational speed ω_ref′ reaches a rotational speed according to which the rotation phase θ is determined with a high degree of accuracy, control of the motor is switched from constant current control to vector control. Thus, in the first exemplary embodiment, vector control is performed after driving of the motor is started with constant current control. In the fourth exemplary embodiment, a configuration in which driving of the motor is started with vector control without constant current control being performed is described.

### [Motor Control Device]

Next, the motor control device 157 in the fourth exemplary embodiment is described. Furthermore, while, in the following description, vector control in the fourth exemplary embodiment is described, the motor control device 157 in the fourth exemplary embodiment also includes a configuration which performs constant current control described in the first exemplary embodiment, thus being also able to perform control of the motor by constant current control.

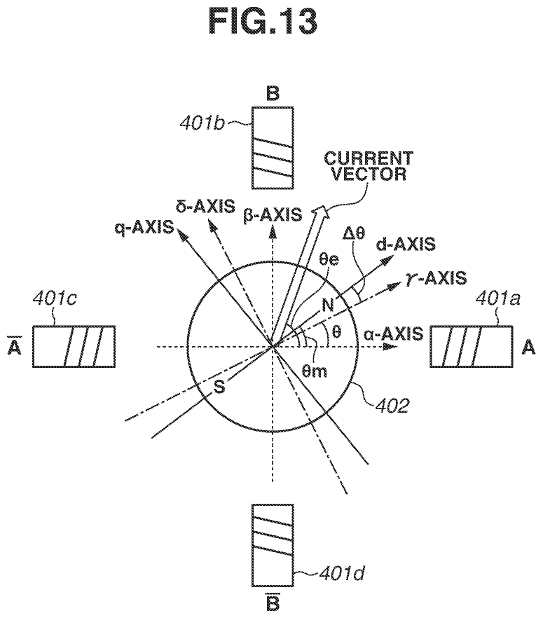

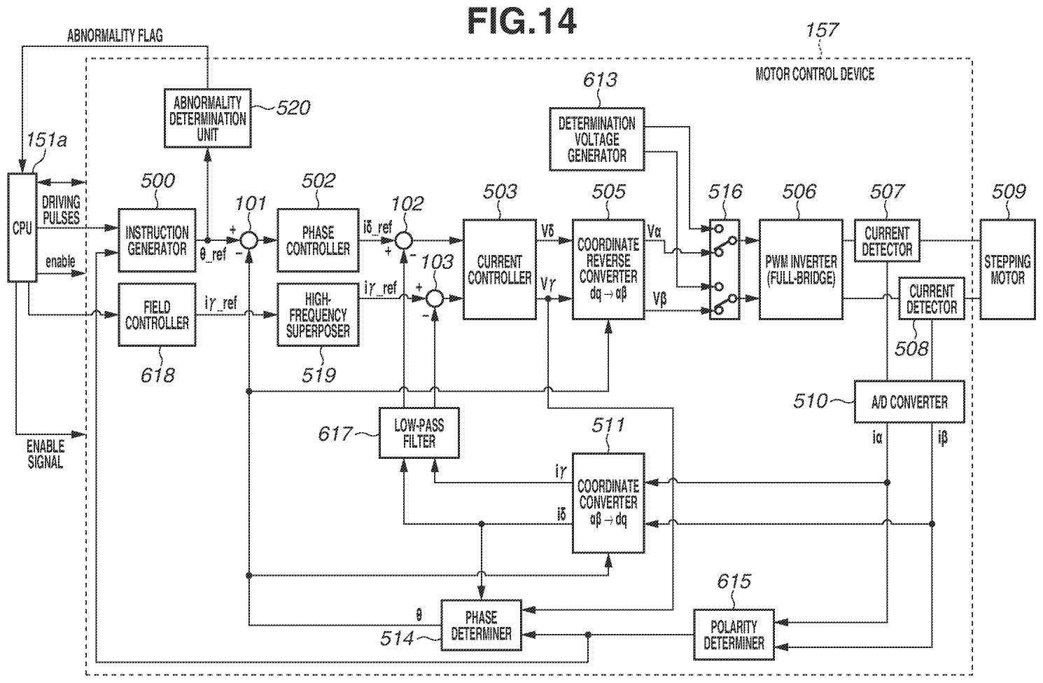

First, the method by which the motor control device 157 in the fourth exemplary embodiment performs vector control is described with reference to FIG. 13 and FIG. 14. Furthermore, a motor to be mentioned in the following description is not provided with a sensor, such as a rotary encoder, for detecting the rotation phase of the rotor of the motor.

FIG. 13 is a diagram illustrating a relationship between a stepping motor (hereinafter referred to as a “motor”) 509 having two phases, i.e., A-phase (first phase) and B-phase (second phase), a rotating coordinate system expressed by a d-axis and a q-axis, and a rotating coordinate system expressed by a γ-axis and a δ-axis. In FIG. 13, in the stationary coordinate system, an α-axis, which is an axis corresponding to the winding of A-phase, and a β-axis, which is an axis corresponding to the winding of B-phase, are defined. Moreover, in FIG. 13, the d-axis is defined along the direction of a magnetic flux generated by magnetic poles of a permanent magnet used for the rotor 402, and the q-axis is defined along a direction which has advanced 90 degrees counterclockwise from the d-axis (along a direction perpendicular to the d-axis). An angle between the α-axis and the d-axis is defined as a second rotation phase θm. Moreover, in FIG. 13, the γ-axis is defined along a direction having a phase difference Δθ from the d-axis, and the δ-axis is defined along a direction which has advanced 90 degrees counterclockwise from the γ-axis (along a direction perpendicular to the γ-axis). An angle between the α-axis and the γ-axis is defined as a rotation phase θ. Thus, Δθ, θm, and θ have a relationship expressed by the following equation (21).

Δθ=θm−θ (21)

In vector control, a component in a q-axis direction for causing the rotor to generate torque (torque current component) and a component in a d-axis direction affecting the intensity of a magnetic flux penetrating through the winding (excitation current component), which are current components in the rotating coordinate system of a current vector corresponding to a driving current flowing through the winding, are used, In vector control in the fourth exemplary embodiment, a rotating coordinate system that is based on the phase θ, i.e., a rotating coordinate system expressed by the γ-axis and the δ-axis, is used. Furthermore, the γ-axis is an axis corresponding to the d-axis (i.e., an axis representing an excitation current component), and the δ-axis is an axis corresponding to the q-axis(i.e., an axis representing a torque current component).

FIG. 14 is a block diagram illustrating an example of a configuration of the motor control device 157, which controls the motor 509. Furthermore, the motor control device 157 is configured with at least one ASIC and performs various functions described below.

The motor control device 157 determines a phase θ representing the rotation phase of the rotor 402 of the motor 509 by the method described below, and performs vector control based on a result of such determination. The CPU 151a outputs, to the instruction generator 500, driving pulses as an instruction to drive a motor, based on the operation sequence of the motor 509. Furthermore, the operation sequence of the motor (a drive pattern of the motor) is stored in, for example, the ROM 151b, and the CPU 151a outputs driving pulses as a pulse train based on the operation sequence stored in the ROM 151b.

The instruction generator 500 generates and outputs an instructed phase θ_ref, which represents a target phase of the rotor 402, based on driving pulses output from the CPU 151a.

The subtractor 101 calculates and outputs a deviation between the phase θ and the instructed phase θ_ref.

The phase controller 502 acquires the deviation between the phase θ and the instructed phase θ_ref with a period T (for example, with a period of 200 μs). The phase controller 502 generates and outputs a δ-axis current instructed value (target value) iδ_ref in such a manner that the deviation output from the subtractor 101 becomes smaller, based on PID control. Specifically, the phase controller 502 generates and outputs the δ-axis current instructed value iδ_ref in such a manner that the deviation output from the subtractor 101 becomes 0, based on PID control. Furthermore, while the phase controller 502 in the fourth exemplary embodiment generates the δ-axis current instructed value iδ_ref based on PID control, the fourth exemplary embodiment is not limited to this. For example, the phase controller 502 can generate the δ-axis current instructed value iδ_ref based on PI control.

A field controller 618 generates and outputs a γ-axis current instructed value iγ_ref based on an instructed output from the CPU 151a. Furthermore, while, in a case where a permanent magnet is used for the rotor 402, usually, the γ-axis current instructed value iγ_ref, which affects the intensity of a magnetic flux penetrating through the winding, is set to 0, the fourth exemplary embodiment is not limited to this.

A high-frequency superposer 519 superposes a signal having a predetermined frequency on the γ-axis current instructed value iγ_ref output from the field controller 618, and outputs a γ-axis current instructed value iγ_ref′ with the signal having a predetermined frequency superposed thereon. In this way, in the fourth exemplary embodiment, the signal having a predetermined frequency (hereinafter referred to as a “high-frequency signal”) is superposed on the γ-axis current, the contribution of which to the torque of the rotor 402 is relatively small. As a result, compared with a case where the high-frequency signal is superposed on the δ-axis current, the contribution of which to the torque of the rotor 402 is relatively large, the variation of a torque caused by the high-frequency signal becomes unlikely to occur. As a result, compared with a case where the high-frequency signal is superposed on the δ-axis current, it is possible to prevent or reduce control of the motor from becoming unstable. Furthermore, the frequency of the high-frequency signal is set to a frequency higher than the highest frequency out of δ-axis current instructed values iδ_ref generated by the phase controller 502, i.e., current values used to rotate the motor 509. Moreover, the frequency of the high-frequency signal is set to a frequency lower than the frequency at which the A/D converter 510 described below converts an analog value into a digital value. Moreover, the amplitude of the high-frequency signal is set to an amplitude which is larger than the amplitude having a magnitude required to determine the phase θ with a high degree of accuracy and which is smaller than the amplitude having a magnitude which does not cause an abnormal sound to be generated due to the high-frequency signal.

A current which flows through the winding of A-phase of the motor 509 is detected by the current detector 507, and is then converted by the A/D converter 510 from an analog value into a digital value. The A/D converter 510 outputs a current value is as the digital value. Moreover, a current which flows through the winding of B-phase of the motor 509 is detected by the current detector 508, and is then converted by the A/D converter 510 from an analog value into a digital value. The A/D converter 510 outputs a current value iβ as the digital value. Furthermore, the period with which the A/D converter 510 converts the current value from an analog value into a digital value and outputs the digital value is a period (for example, 25 μs) less than or equal to the period T with which the phase controller 502 acquires a deviation between the phase θ and the instructed phase θ_ref. Moreover, the current values iα and iβ include current values of driving currents and current values of high-frequency currents caused by high-frequency signals higher in frequency than the driving currents.

The current values iα and iβ are input to the coordinate converter 511 and a polarity determiner 615.

The coordinate converter 511 converts the current value iα and iβ in the stationary coordinate system into a current value iδ of the δ-axis current and a current value iγ of the γ-axis current in the rotating coordinate system by the following equations (22) and (23).

iγ=cos θ*iα+sin θ*iβ (22)

iδ=−sin θ*iα+cos θ*iβ (23)

The current value iδ is output to a low-pass filter 617 and the phase determiner 514. Moreover, the current value iγ is output to the low-pass filter 617.

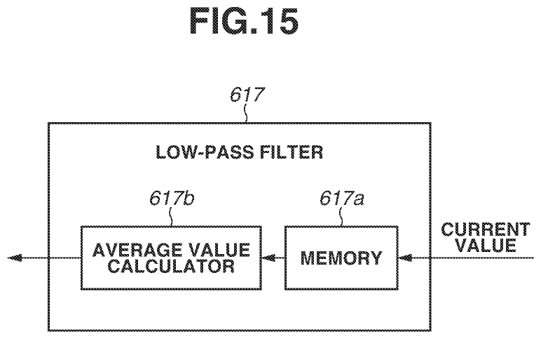

FIG. 15 is a diagram illustrating an example of a configuration of the low-pass filter 617, which reduces signals of a predetermined frequency band. Furthermore, the predetermined frequency band does not include frequencies of driving currents but includes frequencies of high-frequency currents higher in frequency than the driving currents. The low-pass filter 617 in the fourth exemplary embodiment is a digital filter in which filter orders corresponding to the predetermined frequency band are set. As illustrated in FIG. 15, the low-pass filter 617 includes a memory 617a, which stores a plurality of acquired current values, and an average value calculator 617b, which calculates the average value of a plurality of current values stored in the memory 617a.

The low-pass filter 617 stores the acquired current values in the memory 617a, and the average value calculator 617b calculates the average value of current values stored in the memory 617a. Specifically, for example, in a case where the number of orders of the low-pass filter 617 is 30, the low-pass filter 617 stores 30 acquired current values in the memory 617a, and calculates the average value of the 30 current values. Furthermore, when acquiring the 31st and subsequent current values, each time acquiring one current value, the memory 617a deletes the oldest stored current value out of the stored current values and stores the acquired current value. Moreover, the average value calculator 617b performs the above-mentioned calculation each time the memory 617a stores a current value. Additionally, the configuration of the filter is not limited to a configuration which calculates the average value as mentioned above, but only needs to be a filter which is able to reduce signals.

The low-pass filter 617 eliminates high-frequency currents included in the current values iα and iβ, and outputs current values with high-frequency currents eliminated therefrom.

The subtractor 102 receives, as inputs, the δ-axis current instructed value iδ_ref output from the phase controller 502 and the current value iδ output from the low-pass filter 617. The subtractor 102 calculates a deviation between the δ-axis current instructed value iδ_ref and the current value iδ, and outputs the calculated deviation to the current controller 503.

Moreover, the subtractor 103 receives, as inputs, the γ-axis current instructed value iγ_ref output from the high-frequency superposer 519 and the current value iγ output from the low-pass filter 617. The subtractor 103 calculates a deviation between the γ-axis current instructed value iγ_ref and the current value iγ, and outputs the calculated deviation to the current controller 503.

The current controller 503 generates a driving voltage Vδ in such a manner that the deviation output from the subtractor 102 becomes smaller, based on PID control. Specifically, the current controller 503 generates a driving voltage Vδ in such a manner that the deviation output from the subtractor 102 becomes 0, and outputs the driving voltage Vδ to the coordinate reverse converter 505.

Moreover, the current controller 503 generates a driving voltage Vγ in such a manner that the deviation output from the subtractor 103 becomes smaller, based on PID control. Specifically, the current controller 503 generates a driving voltage Vγ in such a manner that the deviation output from the subtractor 103 becomes 0, and outputs the driving voltage Vγ to the coordinate reverse converter 505 and the phase determiner 514.

Furthermore, while the current controller 503 in the fourth exemplary embodiment generates the driving voltages Vδ and Vγ based on PID control, the fourth exemplary embodiment is not limited to this. For example, the current controller 503 can generate the driving voltages Vδ and Vγ based on PI control.

The coordinate reverse converter 505 reversely converts the driving voltages Vδ and Vγ in the rotating coordinate system output from the current controller 503 into driving voltages Vα and Vβ in the stationary coordinate system by the following equations (24) and (25).

Vα=cos θ*Vγ−sin θ*Vδ (24)

Vβ=sin θ*Vγ+cos θ*Vδ (25)

The driving voltages Vα and Vβ obtained by reverse conversion performed by the coordinate reverse converter 505 are output to a voltage switcher 516.

The PWM inverter 506 includes a full-bridge circuit. The full-bridge circuit is driven by pulse width modulation (PWM) signals that are based on voltages input via the voltage switcher 516. As a result, the PWM inverter 506 generates driving currents iα and iβ that correspond to the driving voltages Vα and Vβ, and supplies the generated driving currents iα and iβ to the windings of the respective phases of the motor 509, thus driving the motor 509. Furthermore, while, in the fourth exemplary embodiment, the PWM inverter 506 includes a fall-bridge circuit, the PWM inverter 506 can include, for example, a half-bridge circuit.

{Configuration which Determines Phase θ}

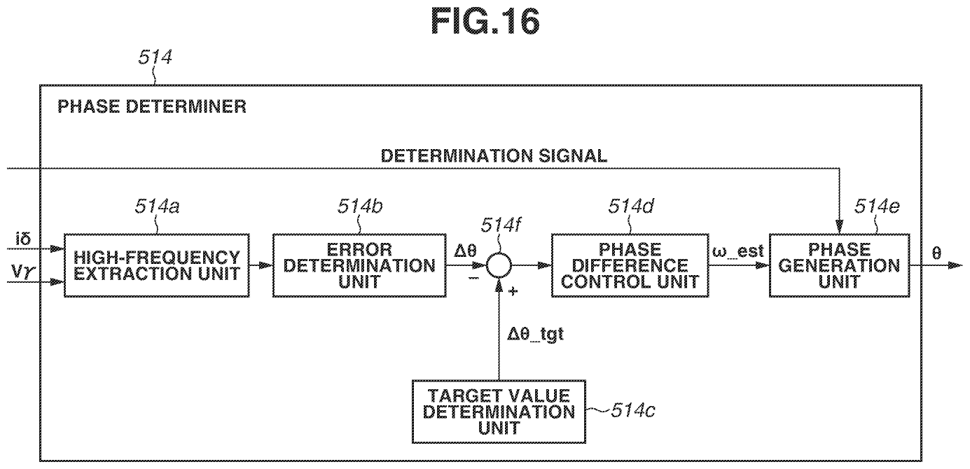

Next, a configuration which determines the phase θ is described. FIG. 16 is a block diagram illustrating a configuration of the phase determiner 514. As illustrated in FIG. 16, the phase determiner 514 includes a high-frequency extraction unit 514a, an error determination unit 514b, a target value determination unit 514c, a phase difference control unit 514d, a phase generation unit 514e, and a subtractor 514f.

The high-frequency extraction unit 514a, which serves as an extraction unit, receives, as inputs, the driving voltage Vγ output from the current controller 503 and the current value iδ output from the coordinate converter 511. The high-frequency extraction unit 514a includes, for example, a bandpass filter which extracts signals of a predetermined frequency band (which reduces signals other than those of a predetermined frequency band). The high-frequency extraction unit 514a extracts signals of a frequency band including the frequency of a high-frequency signal which the high-frequency superpose 519 superposes on the γ-axis current instructed value iγ_ref. As a result, the high-frequency extraction unit 514a is able to extract a high-frequency voltage VγH included in the driving voltage Vγ and a high-frequency current iδH included in the current value iδ. The high-frequency extraction unit 514a outputs the extracted high-frequency voltage VγH and high-frequency current iδH to the error determination unit 514b. Furthermore, in the fourth exemplary embodiment, the high-frequency extraction unit 514a includes a bandpass filter, but can include a filter such as a high-pass filter.

The error determination unit 514b, which serves as a phase difference determination unit, determines the phase difference Δθ with use of the following equations (26) based on the input high-frequency voltage VγH and high-frequency current iδH.

$$Δ θ = \frac{1}{2} \times ( \frac{{L}_{2}}{{L}_{1}} \times \frac{{pi}_{δ H}}{{V}_{γ H}} ) , {L}_{1} = \frac{{L}_{d} - {L}_{q}}{2} , {L}_{2} = {L}_{d} {L}_{q} \qquad ( 26 )$$

Furthermore, Ld and Lq are a winding inductance corresponding to the d-axis direction and a winding inductance corresponding to the q-axis direction, respectively. Ld and Lq are values specific to the motor A serving as the motor 509 used in the fourth exemplary embodiment, and are previously stored in the ROM 151b. Furthermore, control values for the motor B are also previously stored in the ROM 151b. The CPU 151a sets, as control values, either the control values for the motor A or the control values for the motor B based on the type of a motor mounted to the motor control device 157. Moreover, p is a differential operator.

The method of deriving the equations (26) is described as follows. The equations (26) are derived based on the following voltage current equation (27) in a rotating coordinate system that is based on the d-axis and the q-axis.

$$[ \begin{matrix}{v}_{d} \\ {v}_{q}\end{matrix} ] = [ \begin{matrix}R + {pL}_{d} & - ω {L}_{q} \\ ω {L}_{d} & R + {pL}_{q}\end{matrix} ] [ \begin{matrix}{i}_{d} \\ {i}_{q}\end{matrix} ] + [ \begin{matrix}0 \\ ω ψ\end{matrix} ] \qquad ( 27 )$$

Furthermore, Vd and Vq are a driving voltage in the d-axis and a driving voltage in the q-axis, respectively. R, which serves as a control value, is the resistance value of the winding and is a value specific to the motor. Moreover, id and iq are a driving current in the d-axis and a driving current in the q-axis, respectively, and ω is a rotational speed of the rotor. Additionally, ψ, which serves as a control value, is a counter-electromotive voltage coefficient and is a value specific to the motor.

The following voltage current equations (28) in a rotating coordinate system that is based on the γ-axis and the δ-axis, which has a phase difference Δθ from the rotating coordinate system that is based on the d-axis and the q-axis, are derived in the following way based on the equation (27).

$$[ \begin{matrix}{v}_{γ} \\ {v}_{δ}\end{matrix} ] = [ \begin{matrix}{a}_{11} & {a}_{12} \\ {a}_{21} & {a}_{22}\end{matrix} ] [ \begin{matrix}{i}_{γ} \\ {i}_{δ}\end{matrix} ] + ω ψ [ \begin{matrix}sin Δ θ \\ cos Δ θ\end{matrix} ] \\ {a}_{11} = R + p ( {L}_{0} + {L}_{1} cos 2 Δ θ ) + ω {L}_{1} sin 2 Δ θ \\ {a}_{12} = - {pL}_{1} sin 2 Δ θ - ω ( {L}_{0} - {L}_{1} cos 2 Δ θ ) \\ {a}_{21} = - {pL}_{1} sin 2 Δ θ - ω ( {L}_{0} + {L}_{1} cos 2 Δ θ ) \\ {a}_{22} = R + p ( {L}_{0} - {L}_{1} cos 2 Δ θ ) - ω {L}_{1} sin 2 Δ θ \\ {L}_{0} = \frac{{L}_{d} + {L}_{q}}{2} \qquad ( 28 )$$

Here, in the fourth exemplary embodiment, the following conditions are set with respect to, for example, the rotational speed ω, the resistance value R, and the counter-electromotive voltage coefficient ψ.

Condition 1: Since the method of determining the phase θ in the fourth exemplary embodiment is a method which is used in the state in which the rotor is at a stop and the state in which the rotor is rotating at relatively low speed, the rotational speed ω is approximated to 0.
Condition 2: Since a high-frequency signal is used for the method of determining the phase θ in the fourth exemplary embodiment and, therefore, the resistance value R of the winding is sufficiently small with respect to a voltage drop caused by the inductance, the resistance value R is approximated to 0.
Condition 3: Since the frequency of a counter-electromotive voltage generated at the winding is sufficiently lower than the frequency of the high-frequency signal, the counter-electromotive voltage coefficient y is approximated to 0.
Condition 4: Since the high-frequency signal is superposed on only the γ-axis, the voltage Vδ in the δ-axis is approximated to 0.

When, in the above-described way, the rotational speed ω=0, the resistance value R=0, the counter-electromotive voltage coefficient ψ=0, and the voltage Vδ=0 are applied to the equations (28), the following equation (29) is derived.

$$P [ \begin{matrix}{i}_{γ H} \\ {i}_{δ H}\end{matrix} ] = \frac{1}{{L}_{0}^{2} {L}_{1}^{2}} [ \begin{matrix}{L}_{0} - {L}_{1} cos 2 Δ θ \\ {L}_{1} sin 2 Δ θ\end{matrix} ] \qquad ( 29 )$$

Then, when the equation (29) is subjected to equation transformation, the equations (26) about the phase difference δθ are derived. In the above-described way, in the fourth exemplary embodiment, deriving the equations about the phase difference Δθ is simplified by the conditions 1 to 4, so that a calculation load in determining the phase difference Δθ can be reduced. Thus far is the description of the method of driving the equations (26).

The subtractor 514f calculates a deviation between the phase difference Δθ output from the error determination unit 514b and a target value Δθ_tgt for the phase difference Δθ, which is output from the target value determination unit 514c, and outputs the calculated deviation.

The phase difference control unit 514d, which serves as a speed determination unit, generates a rotational speed west in such a manner that the deviation output from the subtractor 514f becomes smaller based on Pin control. Specifically, the phase difference control unit 514d generates a rotational speed ω_est in such a manner that the deviation output from the subtractor 514f becomes θ, and outputs the rotational speed west to the phase generation unit 514e. Furthermore, while the phase difference control unit 514d in the fourth exemplary embodiment generates the rotational speed west based on PID control, the fourth exemplary embodiment is not limited to this. For example, the phase difference control unit 514d can generate the rotational speed west based on PI control.

The phase generation unit 514e generates a phase θ′ based on the rotational speed west output from the phase difference control unit 514d. Specifically, the phase generation unit 514e generates a phase θ′ by performing an integration operation on the rotational speed west output from the phase difference control unit 514d. The phase generation unit 514e corrects the phase θ′ based on a result of polarity determination described below, and outputs a phase θ obtained by correction.

Furthermore, in the fourth exemplary embodiment, the target value Δθ_tgt which is output from the target value determination unit 514c is set to 0. Thus, the phase θ is determined in such a manner that the phase difference Δθ between the d-axis and the γ-axis becomes 0. As a result, motor control is performed based on the more accurately determined phase θ.

The phase θ obtained in the above-described way is input to the subtractor 101, the coordinate reverse converter 505, and the coordinate converter 511.

When performing vector control, the motor control device 157 repetitively performs the above-described control.

As described above, the motor control device 157 in the fourth exemplary embodiment performs vector control using phase feedback control for controlling the current value in the rotating coordinate system in such a manner that a deviation between the instructed phase θ_ref and the rotation phase θ becomes smaller. Performing vector control allows preventing or reducing an increase in motor sound and an increase in power consumption caused by extra torque. Moreover, feeding back the rotation phase allows performing control in such a manner that the rotation phase of the rotor becomes a predetermined phase. Accordingly, vector control using phase feedback control is applied to a motor which drives a load (for example, a registration roller) the rotation phase of which is required to be controlled with a high degree of accuracy to appropriately perform image formation on a recording medium. As a result, image formation on a recording medium can be appropriately performed.

### {Control of Starting of Driving of Motor}

Next, control of starting of driving of the motor in the fourth exemplary embodiment is described. In the fourth exemplary embodiment, vector control is started after polarity determination for determining whether the rotation phase Om of the rotor of the motor is 0°≤θm<90° or 270°≤θm<360° or is 90°≤θm<270° is performed.

The method for polarity determination in the fourth exemplary embodiment is described as follows. The motor control device 157 in the fourth exemplary embodiment includes, as a configuration for determining polarity, a determination voltage generator 613, a polarity determiner 615, and a voltage switcher 516.

When performing polarity determination (starting driving of the motor), the CPU 151a outputs, to the motor control device 157, an instruction to control the voltage switcher 516 in such a manner that a voltage generated by the determination voltage generator 613 is input to the PWM inverter 506. The motor control device 157 controls the voltage switcher 516 in response to the received instruction. As a result, the voltage generated by the determination voltage generator 613 is input to the PWM inverter 506, so that an operation for polarity determination is started.

The determination voltage generator 613 generates a determination voltage Vα0, which is a positive voltage, and outputs the determination voltage Vα0 in such a manner that a current iα0 corresponding to the determination voltage Vα0 flows to the winding of A-phase for a predetermined time T1.

In response to the determination voltage Vα0, the PWM inverter 506 supplies the current iα0 corresponding to the determination voltage Vα0 to the winding of A-phase. Furthermore, the predetermined time T1 is assumed to be a time longer than or equal to a minimum necessary time required for the current iα0 to flow to the winding of A-phase.

The A/D converter 510 converts a current iα0 detected by the current detector 507 from an analog value into a digital value, and outputs the digital value.

A predetermined time T2 after the determination voltage generator 613 outputs the determination voltage Vα0, the determination voltage generator 613 generates a determination voltage Vα0′ and outputs the determination voltage Vα0′ in such a manner that a current iα0′ corresponding to the determination voltage Vα0′ flows to the winding of A-phase for the predetermined time T1, Furthermore, the determination voltage Vα0′ is a voltage which is the same in magnitude as the determination voltage Vα0, and is a voltage which is opposite in polarity to the determination voltage Vα0.

In response to the determination voltage Vα0′, the PWM inverter 506 supplies a current iα0′ corresponding to the determination voltage Vα0′ to the winding of A-phase. Furthermore, the predetermined time T2 is a time longer than or equal to a minimum necessary time required until the current iα0 flowing through the winding of A-phase due to the determination voltage Vα0 becomes 0.

The A/D converter 510 converts a current iα0′ detected by the current detector 507 from an analog value into a digital value, and outputs the digital value.

In a case where a direction in which a magnetic flux generated by the magnetic poles of a permanent magnet penetrates through the winding is the same as the direction of a magnetic flux generated due to a current flowing through the winding, the current becomes likely to flow through the winding. Moreover, in a case where a direction in which a magnetic flux generated by the magnetic poles of a permanent magnet penetrates through the winding is opposite to the direction of a magnetic flux generated due to a current flowing through the winding, the current becomes unlikely to flow through the winding.

Accordingly, the polarity determiner 615 is able to determine polarity by comparing the maximum value of the current iα0 and the maximum value of the current iα0′ with each other.

If the maximum value of the current iα0 is larger than the maximum value of the current iα0′, the polarity determiner 615 outputs a determination signal “0” to the phase generation unit 514e included in the phase determiner 514 and the instruction generator 500.

Moreover, if the maximum value of the current iα0′ is larger than the maximum value of the current iα0, the polarity determiner 615 outputs a determination signal “1” to the phase generation unit 514e included in the phase determiner 514 and the instruction generator 500.

Upon completion of the above-described polarity determination, the motor control device 157 notifies the CPU 151a that the polarity determination is completed.

Upon receiving a notification indicating that the polarity determination is completed, the CPU 151a outputs, to the motor control device 157, an instruction to control the voltage switcher 516 in such a manner that the voltage output from the coordinate reverse converter 505 is input to the PWM inverter 506. In response to the received instruction, the motor control device 157 controls the voltage switcher 516. As a result, the voltage switcher 516 enters a state in which the voltage output from the coordinate reverse converter 505 is input to the PWM inverter 506.

After that, the CPU 151a starts outputting driving pulses. As a result, the above-described vector control is started.

Furthermore, the above-described method of determining polarity is merely an example in the fourth exemplary embodiment, and the fourth exemplary embodiment is not limited to this. For example, polarity determination can be performed with use of a simplified sensor for polarity determination (for example, a Hall effect sensor).

As described above, in the fourth exemplary embodiment, driving of the motor is started with vector control without constant current control being performed.

In the fourth exemplary embodiment, in a case where no jamming of a sheet occurs, the enable signal is set to “1”. As a result, the motor control device 157 drives the motor with vector control. On the other hand, if jamming of a sheet occurs, the CPU 151a checks whether the rotation of the motor mounted to the motor control device 157 is abnormal. Then, if the abnormality flag is “1”, the enable signal is set to “0”. As a result, the motor control device 157 drives the motor with constant current control. In this way, in the fourth exemplary embodiment, when it is detected that the motor is abnormal, the motor control device 157 drives the motor with constant current control. As a result, it is possible to prevent or reduce an abnormality of the rotation of the motor from repetitively occurring due to vector control being performed in the state in which control values set in the motor control device 157 are different from control values corresponding to the motor mounted to the motor control device 157.

Furthermore, while, in the fourth exemplary embodiment, when the abnormality flag is “1”, the CPU 151a controls the motor control device 157 in such a way as to drive the motor mounted to the motor control device 157 not with vector control but with constant current control, the fourth exemplary embodiment is not limited to this. For example, a configuration in which, when jamming of a sheet occurs, the CPU 151a controls the motor control device 157 in such a way as to drive the motor not with vector control but with constant current control irrespective of the abnormality flag can be employed.

Furthermore, the motor control device 157 which performs vector control in the fourth exemplary embodiment can also be applied to the second exemplary embodiment and the third exemplary embodiment.

Moreover, in vector control in the fourth exemplary embodiment, speed feedback control can be applied.

A configuration in which the function of the abnormality determination unit 520 described in any of the first exemplary embodiment to the fourth exemplary embodiment is included in the CPU 151a can be employed.

Moreover, while, in the first exemplary embodiment to the fourth exemplary embodiment, abnormality determination is performed based on the deviation Δθ, the first exemplary embodiment to the fourth exemplary embodiment are not limited to this. For example, abnormality determination can be performed based on a deviation Δω between the rotational speed ω of the rotor and the instructed speed ω_ref. Moreover, abnormality determination can be performed based on the current value id.

The rotational speed ω_ref′ can be determined based on a period with which the magnitude of a periodic signal correlated with a rotational period of the rotor 402, such as the driving current iα or iβ, the driving voltage Vα or Vβ, or the induced voltage Eα or Eβ, becomes 0.

Control to which the first exemplary embodiment to the fourth exemplary embodiment are applied is not limited to motor control using vector control. For example, the first exemplary embodiment to the fourth exemplary embodiment can be applied to any motor control device having a configuration which feeds back the rotation phase or the rotational speed.

Moreover, a first control circuit is equivalent to a circuit which controls driving of the motor 509 with use of the constant current controller 517. Additionally, a second control circuit is equivalent to a circuit which performs driving of the motor 509 with use of the vector controller 518. Furthermore, while, in the motor control device, there are partially shared portions (for example, the current controller 503 and the PWM inverter 506) between a circuit which performs vector control and a circuit which performs constant current control, the motor control device is not limited to this. For example, a configuration in which a circuit which performs vector control and a circuit which performs constant current control are provided independently from each other can be employed.

Furthermore, while, in the first exemplary embodiment the fourth exemplary embodiment, a stepping motor is used as the motor which drives a load, another type of motor, such as a direct-current (DC) motor, can be used. Moreover, the motor is not limited to a two-phase motor, and the first exemplary embodiment to the fourth exemplary embodiment can also be applied to another type of motor, such as a three-phase motor.

Moreover, while, in the first exemplary embodiment to the fourth exemplary embodiment, a permanent magnet is used as the rotor, the first exemplary embodiment to the fourth exemplary embodiment are not limited to this.

According to exemplary embodiments of the present disclosure, it is possible to prevent or reduce abnormality of the rotation of the motor from repetitively occurring.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No, 2018-205555 filed Oct. 31, 2018, which is hereby incorporated by reference herein in its entirety.

What is claimed is:

1. A sheet conveyance apparatus comprising:
a conveyance unit configured to convey a sheet;
a motor configured to drive the conveyance unit;
a motor control device configured to control driving of the motor based on an instructed phase representing a target phase of a rotor of the motor;
a sheet sensor configured to detect presence or absence of the sheet;
a first detector configured to detect an abnormality of conveyance of the sheet based on a result of detection performed by the sheet sensor; and
a first controller configured to control conveyance of the sheet performed by the conveyance unit and to control the motor control device in such a way as to stop driving of the motor in response to an abnormality of conveyance of the sheet being detected by the first detector,
wherein the motor control device includes:
a second detector configured to detect a driving current flowing through a winding of the motor,
a phase determiner configured to determine a rotation phase of the rotor based on the driving current detected by the second detector and a previously set control value,
a second controller including a first mode which controls the driving current flowing through the winding of the motor in such a manner that a deviation between the rotation phase determined by the phase determiner and the instructed phase is reduced, and a second mode which controls the driving current based on a current having a previously determined magnitude, wherein the second controller is configured to switch a control mode for controlling the driving current from the second mode to the first mode in a case where a value corresponding to a target speed of the rotor becomes a value larger than a predetermined value during execution of the second mode after driving of the motor is started with the second mode, and
a discriminator configured to determine whether rotation of the motor is abnormal, and
wherein, in a case where driving of the motor has been stopped due to an abnormality of conveyance of the sheet being detected by the first detector and it is determined by the discriminator that rotation of the motor is abnormal, the second controller starts driving of the motor with the second mode and maintains the second mode even if the value corresponding to the target speed becomes larger than the predetermined value.

2. The sheet conveyance apparatus according to claim 1,
wherein one of a first motor and a second motor which differs in type from the first motor is able to be mounted, as the motor, to the motor control device, and
wherein the motor control device further includes:
a motor discrimination unit configured to discriminate a type of a motor mounted to the motor control device, and
a setting unit configured to set, as the previously set control value, one of a value corresponding to the first motor and a value corresponding to the second motor based on a result of discrimination performed by the motor discrimination unit.

3. The sheet conveyance apparatus according to claim 2, wherein the motor control device further includes a notification unit configured to issue a notification indicating that ae third motor has been mounted to the motor control device in a case where it is determined by the motor discrimination unit that the third motor, which differs in type from the first motor and the second motor, has been mounted to the motor control device.

4. The sheet conveyance apparatus according to claim 2, wherein, in a case where it is determined by the motor discrimination unit that a third motor, which differs in type from the first motor and the second motor, has been mounted to the motor control device, the second controller maintains the second mode even if the value corresponding to the target speed becomes larger than the predetermined value.

5. The sheet conveyance apparatus according to claim 1, wherein the abnormality of rotation of the motor corresponds to the motor being in a step-out state.

6. A sheet conveyance apparatus comprising:
a conveyance unit configured to convey a sheet;
a motor configured to drive the conveyance unit;
a motor control device configured to control driving of the motor based on an instructed speed representing a target speed of a rotor of the motor;
a sheet sensor configured to detect presence or absence of the sheet;
a first detector configured to detect an abnormality of conveyance of the sheet based on a result of detection performed by the sheet sensor; and
a first controller configured to control conveyance of the sheet performed by the conveyance unit and to control the motor control device in such a way as to stop driving of the motor in response to an abnormality of conveyance of the sheet being detected by the first detector,
wherein the motor control device includes:
a second detector configured to detect a driving current flowing through a winding of the motor,
a speed determiner configured to determine a rotational speed of the rotor based on the driving current detected by the second detector and a previously set control value,
a second controller including a first mode which controls the driving current flowing through the winding of the motor in such a manner that a deviation between the rotational speed determined by the speed determiner and the instructed speed is reduced, and a second mode which controls the driving current based on a current having a previously determined magnitude, wherein the second controller is configured to switch a control mode for controlling the driving current from the second mode to the first mode in a case where the instructed speed becomes a value larger than a predetermined value during execution of the second mode after driving of the motor is started with the second mode, and
a discriminator configured to determine whether rotation of the motor is abnormal, and
wherein, in a case where driving of the motor has been stopped, due to an abnormality of conveyance of the sheet being detected by the first detector and it is determined by the discriminator that rotation of the motor is abnormal, the second controller starts driving of the motor with the second mode and maintains the second mode even if the instructed speed becomes larger than the predetermined value.

7. The sheet conveyance apparatus according to claim 6,
wherein one of a first motor and a second motor which differs in type from the first motor is able to be mounted, as the motor, to the motor control device, and
wherein the motor control device further includes:
a motor discrimination unit configured to discriminate a type of a motor mounted to the motor control device, and
a setting unit configured to set, as the previously set control value, one of a value corresponding to the first motor and a value corresponding to the second motor based on a result of discrimination performed by the motor discrimination unit.

8. The sheet conveyance apparatus according to claim 7, wherein the motor control device further includes a notification unit configured to issue a notification indicating that a third motor has been mounted to the motor control device in a case where it is determined by the motor discrimination unit that the third motor, which differs in type from the first motor and the second motor, has been mounted to the motor control device.

9. The sheet conveyance apparatus according to claim 7, wherein, in a case where it is determined by the motor discrimination unit that a third motor, which differs in type from the first motor and the second motor, has been mounted to the motor control device, the second controller maintains the second mode even if the instructed speed becomes larger than the predetermined value.

10. The sheet conveyance apparatus according to claim 6, wherein the abnormality of rotation of the motor corresponds to the motor being in a step-out state.

11. A sheet conveyance apparatus comprising:
a conveyance unit configured to convey a sheet;
a motor configured to drive the conveyance unit;
a motor control device configured to control driving of the motor based on an instructed phase representing a target phase of a rotor of the motor;
a sheet sensor configured to detect presence or absence of the sheet;
a first detector configured to detect an abnormality of conveyance of the sheet based on a result of detection performed by the sheet sensor; and
a first controller configured to control conveyance of the sheet performed by the conveyance unit and to control the motor control device in such a way as to stop driving of the motor in response to an abnormality of conveyance of the sheet being detected by the first detector,
wherein the motor control device includes:
a second controller including a first mode which controls the motor based on a first current which is to be supplied so as to reduce a deviation between a rotation phase of the rotor and the instructed phase and a second current which is higher in frequency than the first current, and a second mode which controls the motor based on a current having a previously determined magnitude,
a second detector configured to detect a driving current flowing through a winding of the motor,
an extraction unit configured to extract signals of a predetermined frequency band including a frequency of the second current from the current detected by the second detector,
a phase determiner configured to determine a rotation phase of the rotor based on signals of the predetermined frequency band extracted by the extraction unit and a set control value, and
a discriminator configured to determine whether rotation of the motor is abnormal,
wherein, in a case where driving of the motor has been stopped due to an abnormality of conveyance of the sheet being detected by the first detector and it is determined by the discriminator that rotation of the motor is not abnormal, the second controller starts driving of the motor with the first mode, and
wherein, in a case where driving of the motor has been stopped due to an abnormality of conveyance of the sheet being detected by the first detector and it is determined by the discriminator that rotation of the motor is abnormal, the second controller starts driving of the motor with the second mode.

12. The sheet conveyance apparatus according to claim 11,
wherein one of a first motor and a second motor which differs in type from the first motor is able to be mounted, as the motor, to the motor control device, and
wherein the motor control device further includes:
a motor discrimination unit configured to discriminate a type of a motor mounted to the motor control device, and
a setting unit configured to set, as the previously set control value, one of a value corresponding to the first motor and a value corresponding to the second motor based on a result of discrimination performed by the motor discrimination unit.

13. The sheet conveyance apparatus according to claim 12, wherein the motor control device further includes a notification unit configured to issue a notification indicating that a third motor has been mounted to the motor control device in a case where it is determined by the motor discrimination unit that the third motor, which differs in type from the first motor and the second motor, has been mounted to the motor control device.

14. The sheet conveyance apparatus according to claim 12, wherein, in a case where it is determined by the motor discrimination unit that a third motor, which differs in type from the first motor and the second motor, has been mounted to the motor control device, the second controller starts driving of the motor with the second mode.

15. The sheet conveyance apparatus according to claim 11, wherein the abnormality of rotation of the motor corresponds to the motor being in a step-out state.

16. A sheet conveyance apparatus comprising:
a conveyance unit configured to convey a sheet;
a motor configured to drive the conveyance unit;
a motor control device configured to control driving of the motor based on an instructed speed representing a target speed of a rotor of the motor;
a sheet sensor configured to detect presence or absence of the sheet;
a first detector configured to detect an abnormality of conveyance of the sheet based on a result of detection performed by the sheet sensor; and
a first controller configured to control conveyance of the sheet performed by the conveyance unit and to control the motor control device in such a way as to stop driving of the motor in response to an abnormality of conveyance of the sheet being detected by the first detector,
wherein the motor control device includes:
a second controller including a first mode which controls the motor based on a first current which is to be supplied so as to reduce a deviation between a rotation speed of the rotor and the instructed speed and a second current which is higher in frequency than the first current, and a second mode which controls the motor based on a current having a previously determined magnitude,
a second detector configured to detect a driving current flowing through a winding of the motor,
an extraction unit configured to extract signals of a predetermined frequency band including a frequency of the second current from the current detected by the second detector,
a speed determiner configured to determine a rotation speed of the rotor based on signals of the predetermined frequency band extracted by the extraction unit and a set control value, and
a discriminator configured to determine whether rotation of the motor is abnormal,
wherein, in a case where driving of the motor has been stopped due to an abnormality of conveyance of the sheet being detected by the first detector and it is determined by the discriminator that rotation of the motor is not abnormal, the second controller starts driving of the motor with the first mode, and
wherein, in a case where driving of the motor has been stopped due to an abnormality of conveyance of the sheet being detected by the first detector and it is determined by the discriminator that rotation of the motor is abnormal, the second controller starts driving of the motor with the second mode.

17. The sheet conveyance apparatus according to claim 16,
wherein one of a first motor and a second motor which differs in type from the first motor is able to be mounted, as the motor, to the motor control device, and
wherein the motor control device further includes:
a motor discrimination unit configured to discriminate a type of a motor mounted to the motor control device, and
a setting unit configured to set, as the previously set control value, one of a value corresponding to the first motor and a value corresponding to the second motor based on a result of discrimination performed by the motor discrimination unit.

18. The sheet conveyance apparatus according to claim 17, wherein the motor control device further includes a notification unit configured to issue a notification indicating that a third motor has been mounted to the motor control device in a case where it is determined by the motor discrimination unit that the third motor, which differs in type from the first motor and the second motor, has been mounted to the motor control device.

19. The sheet conveyance apparatus according to claim 17, wherein, in a case where it is determined by the motor discrimination unit that a third motor, which differs in type from the first motor and the second motor, has been mounted to the motor control device, the second controller starts driving of the motor with the second mode.

20. The sheet conveyance apparatus according to claim 16, wherein the abnormality of rotation of the motor corresponds to the motor being in a step-out state.
